(19) United States
(12) Patent Application Publication
(10) Pub. No.: US 2016/0246981 A1
(43) Pub. Date: Aug. 25, 2016

(54) DATA SECRECY STATISTICAL PROCESSING SYSTEM, SERVER DEVICE FOR PRESENTING STATISTICAL PROCESSING RESULT, DATA INPUT DEVICE, AND PROGRAM AND METHOD THEREFOR

(71) Applicant: INTEC INC., Toyama-shi, Toyama (JP)

(72) Inventors: Ikuo NAKAGAWA, Kanagawa (JP); Mitsuharu GOTO, Tokyo (JP); Yoshifumi HASHIMOTO, Kanagawa (JP)

(73) Assignee: INTEC INC., Toyama-shi, Toyama (JP)

(21) Appl. No.: 15/030,106

(22) PCT Filed: Oct. 21, 2014
(86) PCT No.: PCT/JP2014/005321

§ 371 Date: Apr. 18, 2016

(30) Foreign Application Priority Data
Oct. 23, 2013 (JP) 2013-220673
Aug. 29, 2014 (JP) 2014-176590

(51) Int. Cl. G06F 21/62; H04L 29/06

(52) U.S. Cl. CPC G06F 21/6218; H04L 63/1433; G06F 2221/2115

(57) ABSTRACT

A result of statistical processing for a set of original data items can be obtained while the risk of leakage of information to be hidden is reduced by avoiding transferring and storing original data.

Each of a plurality of data input devices comprises: means for acquiring an original data item to be hidden; and means for dividing the original data item in accordance with a secret ratio where adding up all the partial data items restores the original data item, and outputting a predetermined number of partial data items. Each of a predetermined number of arithmetic devices comprises means for performing a predetermined arithmetic operation based on a plurality of input data items, performs the arithmetic operation using partial data items as the input data items, each partial data item being outputted from each of a plurality of data input devices, and outputs the arithmetic result. A data processing device performs a service that uses the arithmetic result outputted from each of a predetermined number of arithmetic devices, thereby obtaining and providing a statistical processing result based on a plurality of original data items acquired by the plurality of data input devices without acquiring the original data items.

### RELATED APPLICATIONS

This application claims the benefit of Japanese Patent Applications No. 2013-220673 filed on Oct. 23, 2013 in Japan and No. 2014-176590 filed on Aug. 29, 2014 in Japan, the contents of which are incorporated herein by reference.

### TECHNICAL FIELD

The present invention relates to a technology to perform statistical processing on confidential data about individual privacy or the like with the secrecy of the data being maintained and provide the result.

### BACKGROUND ART

In recent years, there have been a growing number of cases where personal information, a behavior record, or other “lifelog” information is analyzed and used in various business settings. Every situation requires analysis of data such as, for example, POS data or another purchase history, a usage history of electronic money, a boarding history of traffic networks, car GPS information, a call history and usage history of a mobile phone, smart phone, or the like, a healthcare-related measurement history of blood pressure, weight, or the like, and also a medical history.

Information obtained from a “lifelog” is often useful, and there are many possible applications such as estimation of behavioral patterns, recommendation, target marketing, and research and development of a new product or method. On the other hand, a great concern exists regarding handling of privacy information during data analysis.

Services are also common that use cloud computing technologies to allow individuals, corporations, or other users to send their own data over networks to data centers or the like and store them there, not on their local devices. In this case, too, privacy information included in data to be stored in the cloud might add to concern about information leakage.

A technique called Privacy-Preserving Data Mining (PPDM) is developed as a technology to analyze data and find a useful knowledge while preserving privacy information (see Non-patent document 1), and a technique called Secret Sharing is proposed as a technology to prevent leakage of secret information even if stored data itself is leaked to a third party (see Patent documents 1 to 3).

### PRIOR ART DOCUMENTS

### Patent Documents

Patent document 1: Japanese Patent Laid-Open Application No. 2013-20314

Patent document 2: Published Japanese Translation of PCT International Publication for Patent Application No. 2012-530391

Patent document 3: Japanese Patent Laid-Open Application No. 2005-250866

### Non-Patent Document

Non-patent document 1: Jun Sakuma and Shigenobu Kobayasi, “Privacy-Preserving Data Mining,” Journal of the Japanese Society for Artificial Intelligence Vol. 24 No. 2 (2009)

### SUMMARY OF THE INVENTION

### Problems to be Solved by the Invention

PPDM has a scheme in which a reliable third-party organization is assumed to exist and confidential original data is passed to the third-party organization. But such a reliable third-party organization is actually impractical and is also an unrealistic solution since an information leakage from the third-party organization where secret information items are collected would cause major damage.

In a PPDM scheme that does not use a reliable third-party organization, original data held by an organization is kept hidden from the outside and a result of an analysis on its set of original data items is obtained outside the organization. An outsider that performs analytical processing is not given the original data but data processed to be concealed in some way and performs the analytical processing. In order to prevent the outsider from obtaining the original data hidden in the organization from the given data during the process, various techniques have been developed.

The scheme that does not use a reliable third-party organization, however, is also premised on the retention of confidential original data inside the organization. This means that PPDM itself is unprotected from the risk of original data held by the organization leaking to a third party, causing the leakage of privacy information.

So, conventional techniques would maintain the security of confidential data by combining PPDM and a technology to hold original data in an encrypted state. But the original data exists even if encrypted, and therefore can be decrypted and obtained with sufficient computational capability and time even though they are required in huge amounts as the encryption intensity increases. Accordingly, the risk of information leakage cannot be excluded and remains.

In contrast to this, the Secret Sharing technique prevents information leakage by dividing secret information into some data items (the number of which is assumed to be N) and holding them in a distributed manner so that the secret information cannot be restored even if K out of N (K<N) data items are leaked to and collected by a third party.

This sharing of secret information means that original data is not retained, and the risk of information leakage can be reduced for sure by increasing the values of N and K. In other words, the secret information is guaranteed not to be leaked even if the retained data items are leaked at K places, and therefore the possibility of the data items leaking from all the K places can be extremely decreased by sufficiently increasing the value of K and enhancing the security of the location where each data item is retained.

However, when the secret information safely retained with the Secret Sharing technique is to be analyzed, the shared data items cannot be analyzed as they are, and therefore the analytical processing has to be performed after all the data items are temporarily brought together in one place and the secret information is restored. This means that the original data is retained during the analysis even if the Secret Sharing technique is used during the usual storage and, as a result, the risk of data leakage leading immediately to information leakage still remains.

A purpose of the invention made in view of the above-mentioned circumstances is to allow a result of statistical processing for a set of original data items to be obtained while the risk of leakage of information to be hidden is reduced by avoiding transferring and storing original data so as not to retain the original data.

### Means for Solving the Problems

A data-hidden statistical processing system of one example according to the principle of the invention comprises: a plurality of data input devices, each comprising means for acquiring an original data item to be hidden; a plurality of arithmetic devices, each comprising means for performing a predetermined arithmetic operation based on a plurality of input data items; and a data processing device comprising means for using a result of an arithmetic operation performed by each of the plurality of arithmetic devices using partial data items as the input data items, each partial data item being a part of the original data item, thereby obtaining a statistical processing result based on a plurality of original data items acquired by the plurality of data input devices without acquiring the original data items.

### Advantages of the Invention

The invention allows a result of statistical processing for a set of original data items to be obtained while the risk of leakage of information to be hidden is reduced by avoiding retaining the original data.

### BRIEF DESCRIPTION OF THE DRAWINGS

FIG. 1 illustrates an example of determining a sum in a data-hidden statistical processing system of an embodiment of the invention (hereinafter referred to as the “present system”);

FIG. 2 illustrates another example of determining a sum in the present system;

FIG. 3 illustrates an example of determining the sum of squares in the present system;

FIG. 4 illustrates another example of determining the sum of squares in the present system;

FIG. 5 illustrates an example of determining an inner product in the present system;

FIG. 6 shows a configuration example of the present system;

FIG. 7 shows a configuration example of a server for providing a statistical processing result of the present system;

FIG. 8 illustrates procedure examples (1) to (3) in the present system;

FIG. 9 illustrates procedure examples (4) to (6) in the present system;

FIG. 10 illustrates procedure examples (7) to (9) in the present system;

FIG. 11 illustrates procedure examples (10) to (12) in the present system;

FIG. 12 illustrates procedure examples (13) to (15) in the present system;

FIG. 13 illustrates procedure examples (16) to (18) in the present system;

FIG. 14 illustrates procedure examples (19) to (21) in the present system;

FIG. 15 illustrates procedure examples (22) to (24) in the present system;

FIG. 16 shows another configuration example of the present system;

FIG. 17 illustrates other procedure examples (1) to (2) in the present system;

FIG. 18 illustrates other procedure examples (3) to (5) in the present system;

FIG. 19 illustrates other procedure examples (6) to (8) in the present system;

FIG. 20 shows still another configuration example of the present system;

FIG. 21 illustrates still other procedure examples (1) to (2) in the present system;

FIG. 22 illustrates still other procedure examples (3) to (6) in the present system;

FIG. 23 illustrates still other procedure examples (7) to (10) in the present system;

FIG. 24 illustrates an example of the present system applied in the field of education;

FIG. 25 illustrates an example of the present system applied in the field of medicine;

FIG. 26 illustrates an example of the present system applied in the field of distribution (retail business); and

FIG. 27 illustrates an example of the present system applied in the field of telematics.

### MODES OF EMBODYING THE INVENTION

In the above-described configuration of the data-hidden statistical processing system of one example according to the principle of the invention, original data obtained by each data input device is converted to partial data items and they are passed to the plurality of arithmetic devices in a distributed manner, so none of the arithmetic devices acquire the original data and neither does the data processing device. Accordingly, this avoidance of holding the original data allows for reducing the risk of leakage of information to be hidden. On the other hand, a result of statistical processing for a set of original data items can be obtained since each arithmetic device performs an arithmetic operation on the partial data items and the data processing device uses arithmetic results obtained from the plurality of arithmetic devices.

In the configuration described above, the data input devices may comprise: means for generating a predetermined number of partial data items by dividing the original data item in accordance with a secret ratio where adding up all the partial data items restores the original data item; and means for transmitting each of the predetermined number of partial data items to a corresponding one of the plurality of arithmetic devices through a protected communication channel.

This can prevent the restoration of the original data provided that the original data is divided into M items and is transmitted to M arithmetic devices and if at most (M−1) partial data items are leaked to a third party. The secrecy of the original data can thus be maintained even if the M arithmetic devices store their own partial data items and some data is leaked from some arithmetic devices to a third party. The protection of the communication channel extending from the data input devices also prevents a third party from acquiring all the partial data items (i.e. the original data) by communication intercepts.

The secret ratio is preferably different for each data input device. Operations management is simplified if the number of partial data items generated by each data input device is identical for all original data items that belong to a set on which one statistical process is performed, but the number may be allowed to be different for each of them.

In the configuration described above, the arithmetic devices may comprise means for transmitting to the data processing device an arithmetic result obtained through a predetermined arithmetic operation based on a plurality of partial data items received from the plurality of data input devices, and the data processing device may comprise means for performing predetermined statistical processing based on a plurality of arithmetic results received from the plurality of arithmetic devices.

This allows a result of statistical processing for N original data items to be obtained by each of M arithmetic devices receiving partial data items from N data input devices and transmitting a result of an arithmetic operation performed on the N partial data items to the data processing device, and by the data processing device processing the M arithmetic results.

In this regard, each arithmetic device receives N data items corresponding to N original data items, but they are partial data items and do not include information of the original data items; and the data processing device receives M arithmetic results corresponding to M partial data items that form original data, but they are information pieces on a set of original data items and do not include information of individual original data items. A result of the statistical processing can thus be obtained without causing each arithmetic device and the data processing device to acquire any original data item.

In the configuration described above, the predetermined number of partial data items may include those generated from the value of each of the partial data items into which the original data item is divided, the predetermined arithmetic operation performed by the arithmetic devices may include a calculation of the sum of the plurality of partial data items, and the predetermined statistical processing performed by the data processing device may include a process to calculate the sum of the predetermined number of arithmetic results.

This allows for obtaining a result of statistical processing for the sum of N original data items, (X₁+X₂+ . . . X_{N}), without acquiring the original data items. For example, the value of (X₁+X₂+ . . . X_{N}) can be determined as follows: the ith data input device (i=1, 2, . . . , N) generates m partial data items xⱼᵢ to satisfy Xᵢ=x₁ᵢ+x₂ᵢ+ . . . +xₘᵢ; the jth arithmetic device (j=1, 2, . . . , m) determines the value of the sum of N partial data items, (xⱼ₁+xⱼ₂+ . . . +x_{jN}); and the data processing device determines the sum of the values determined by the m arithmetic devices.

In the configuration described above, the predetermined number of partial data items may include those generated from the value of each of the partial data items into which the original data item is divided and those generated based on the value of two partial data items different from each other multiplied by each other, the predetermined arithmetic operation performed by the arithmetic devices may include a calculation of at least one of the sum or the sum of squares of the plurality of partial data items, and the predetermined statistical processing performed by the data processing device may include a process to calculate the sum of squares of those of the predetermined number of arithmetic results that correspond to the value of each of the partial data items and a process to calculate the sum of those of the predetermined number of arithmetic results that correspond to the value of the partial data items multiplied by each other.

This allows for obtaining a result of statistical processing for the sum of squares of N original data items, (X₁²+X₂²+ . . . +X_{N}²), without acquiring the original data items. For example, the value of (X₁²+X₂²+ . . . +X_{N}²) can be obtained as follows: the ith data input device (i=1, 2, . . . , N) generates m partial data items xⱼᵢ to satisfy Xᵢ=+x₁ᵢ+x₂ᵢ+ . . . +xₘᵢ and further generates m partial data items [Σ_{j≈k}(xⱼᵢxₖᵢ)] (hereinafter described as “x′ⱼᵢ”); the jth arithmetic device (j=1, 2, . . . , m) determines the value of the sum of squares of N partial data items xⱼᵢ, (xⱼᵢ²+xⱼ₂²+ . . . +x_{jN}²); the jth arithmetic device (j=m+1, m+2, . . . , 2m) determines the value of the sum of N partial data items x′ⱼᵢ, (x′ⱼᵢ+x′ⱼ₂+ . . . +x′_{jN}); and the data processing device determines the sum of the values determined by the 2m arithmetic devices.

For another example, the value of (X₁²+X₂²+ . . . +X_{N}²) can also be obtained as follows: the ith data input device (i=1, 2, . . . , N) generates m partial data items xⱼᵢ to satisfy Xᵢ=x₁ᵢ+x₂ᵢ+ . . . +xₘᵢ and further generates the (m+1)th partial data item [Σⱼ(Σ_{j≈k}(xⱼᵢxₖᵢ))] (hereinafter described as “x″ᵢ”); the jth arithmetic device (j=1, 2, . . . , m) determines the value of the sum of squares of N partial data items xⱼᵢ, (xⱼ₁²+xⱼ₂²+ . . . +x_{jN}²); the (m+1)th arithmetic device determines the value of the sum of N partial data items x″ᵢ, (x″₁+x″₂+ . . . +x″_{N}); and the data processing device determines the sum of the values determined by the (m+1) arithmetic devices.

In an alternative configuration to the configuration described above, the predetermined number of partial data items may include those generated from the value of a square of each of the partial data items into which the original data item is divided and those generated based on the value of two partial data items different from each other multiplied by each other, the predetermined arithmetic operation performed by the arithmetic devices may include a calculation of the sum of the plurality of partial data items, and the predetermined statistical processing performed by the data processing device may include a process to calculate the sum of the predetermined number of arithmetic results.

This also allows for obtaining a result of statistical processing for the sum of squares of N original data items, (X₁²+X₂²+ . . . +X_{N}²), without acquiring the original data items. For example, the value of (X₁²+X₂²+ . . . +X_{N}²) can be obtained as follows: the ith data input device (i=1, 2, . . . , N) defines xⱼᵢ to satisfy Xᵢ=x₁ᵢ+x₂ᵢ+ . . . +xₘᵢ and generates m partial data items xⱼᵢ² and m partial data items x′ⱼᵢ; the jth arithmetic device (j=1, 2, . . . , m) determines the value of the sum of N partial data items xⱼ₁², (xⱼ₁²+xⱼ₂²+ . . . +x_{jN}²); the jth arithmetic device (j=m+1, m+2, . . . , 2m) determines the value of the sum of N partial data items x′ⱼᵢ, (x′ⱼ₁+x′ⱼ₂+ . . . +x′_{jN}); and the data processing device determines the sum of the values determined by the 2m arithmetic devices.

For another example, the value of (X₁²+X₂²+ . . . +X_{N}²) can also be obtained as follows: the ith data input device (i=1, 2, . . . , N) defines xⱼᵢ to satisfy Xᵢ=x₁ᵢ+x₂ᵢ+ . . . +xₘᵢ and generates m partial data items xⱼᵢ² and one partial data item x″ᵢ; the jth arithmetic device (j=1, 2, m) determines the value of the sum of N partial data items xⱼᵢ², (x₁ᵢ²+xⱼ₂²+ . . . +x_{jN}²); the (m+1)th arithmetic device determines the value of the sum of N partial data items x″ᵢ, (x″₁+x″₂+ . . . +x″_{N}); and the data processing device determines the sum of the values determined by the (m+1) arithmetic devices.

In the examples described above, m arithmetic devices are used to determine the sum and 2m or (m+1) arithmetic devices are used to determine the sum of squares. The secrecy of the original data can be maintained in both cases even if data items are leaked from (m−1) locations at the same time.

Each arithmetic device may be configured to perform a uniform process in which it performs arithmetic operations for the sum and the sum of squares on data items received from data input devices and transmits these two arithmetic results to the data processing device regardless of what the data items are, and the data processing device may be configured to choose arithmetic results transmitted from the arithmetic devices in accordance with statistical processing to be performed (e.g. results of the sum of squares are chosen for the first to mth arithmetic devices and results of the sum are chosen for the (m+1)th to 2mth arithmetic devices, etc.) and perform a calculation on them.

The above-described configuration capable of obtaining results of statistical processing for the sum and the sum of squares of a set of original data items may be used for a configuration for obtaining, as the final statistical processing result, the result of at least one of: calculation of sample mean; calculation of sample variance; calculation of sample deviation; maximum likelihood estimation; interval estimation using the t distribution; estimation of a confidence interval for population proportion; estimation of population variance; a test for population mean; a test for the population mean difference between populations A and B; a test for population proportion; a comparison test for population variances of populations A and B; and analysis of variance.

In the configuration describe above, the plurality of data input devices may include a same number of first and second data input devices corresponding to each other, the first and second data input devices may transmit each of the predetermined number of partial data items to a corresponding predetermined number of arithmetic devices among a square number of the predetermined number of the arithmetic devices, the predetermined arithmetic operation performed by the arithmetic devices may include an arithmetic operation to calculate the inner product of a partial data item row from the first data input devices and a partial data item row from the second data input devices, and the statistical processing performed by the data processing device may include a process to calculate the sum of the square number of the predetermined number of the arithmetic results received from the square number of the predetermined number of the arithmetic devices.

This allows for obtaining a result of statistical processing for the inner product of the first set of original data items (N original data items Xᵢ) and the second set of original data items (N original data items Yᵢ), (X₁+X₂+Y₁Y₂+ . . . +X_{N}Y_{N}), without acquiring the original data items. For example, the value of (X₁Y₁+X₂Y₂+ . . . +X_{N}Y_{N}) can be determined as follows: the ith one of the first data input devices (i=1, 2, . . . , N) generates m partial data items xⱼᵢ to satisfy Xᵢ=x₁ᵢ+x₂ᵢ+ . . . +xₘᵢ; the ith one of the second data input devices (i=1, 2, . . . , N) generates m partial data items yₖᵢ, to satisfy Yᵢ=y₁ᵢ+y₂ᵢ+ . . . +yₘᵢ; the jkth arithmetic device (jk=1, 2, . . . , m²) determines the value of the inner product of N partial data items xⱼᵢ and N partial data items yₖᵢ, (xⱼ₁yₖ₁+xⱼ₂yₖ₂+ . . . +x_{jN}y_{kN}); and the data processing device determines the sum of the values determined by the m² arithmetic devices.

The above-described configuration capable of obtaining a result of statistical processing for the inner product of two sets of original data items may be used for a configuration for obtaining, as the final statistical processing result, the result of at least one of: calculation of covariance; calculation of correlation coefficient; and regression analysis.

In the data-hidden statistical processing system described above, the data input devices may further comprise means for determining the secret ratio by using a random number generated when the original data item is divided, and erasing the memory of the secret ratio after the division.

This allows for reducing the risk of information leakage that original data can be restored if the secret ratio is uncovered even when only one of a plurality of partial data items forming the original data is leaked to a third party and the secrecy of the original data should be maintained. The random determination of the secret ratio for each division would reduce the possibility of the ratio being guessed, and the erasure of the memory of the secret ratio would reduce the possibility of information leakage.

In the system described above, the arithmetic devices may further comprise: means for storing each of a plurality of partial data items received from the plurality of data input devices in association with the data input device that sent the relevant partial data item; and means for, in response to a request indicating the association with one of the data input devices, returning one of the plurality of partial data items that is stored in association with the relevant data input device.

This can surely reduce the risk of leakage of information to be hidden, since original data acquired by a data input device is immediately divided and stored in a plurality of arithmetic devices in a distributed manner and therefore the data input device, too, does not retain the original data.

In the configuration described above, a device having the association with one of the data input devices may comprise means for acquiring all the partial data items generated by dividing the original data item from corresponding arithmetic devices of the plurality of arithmetic devices, and restoring the original data item.

This allows the primary holder of the original data to restore the original data by gathering all the plurality of partial data items stored in a distributed manner even if the secret ratio is not recorded.

As an alternative configuration, a device having the association with one of the data input devices may comprise: means for storing the ratio for one of the partial data items into which the original data item is divided; and means for acquiring a partial data item of the partial data items generated by dividing the original data item that corresponds to the one stored ratio from the corresponding arithmetic device of the plurality of arithmetic devices, and restoring the original data item.

This allows the primary holder of the original data to restore the original data by acquiring one of the plurality of partial data items stored in a distributed manner.

In the system described above, the data processing device may comprise: means for indicating to each of the plurality of data input devices which of the plurality of arithmetic devices the data input device is to transmit the partial data items to; and means for indicating to each of the plurality of arithmetic devices which of a plurality of partial data items received from the plurality of data input devices a predetermined arithmetic operation is to be performed on.

This allows for choosing arithmetic devices to be used or specifying the number of arithmetic devices each time depending on what is to be obtained from the statistical processing as a result, and allows for situational load distribution, fine security settings, or the like. Additionally, whether partial data items held by each arithmetic device are those of the original data on which a desired statistical processing is to be performed or not can be notified of to the arithmetic device, and partial data items that cause an erroneous result or the like if included as the subject of the statistical processing can be eliminated from the arithmetic operation.

In the system described above, each of the plurality of data input devices may comprise means for determining which of the plurality of arithmetic devices the partial data items is to be transmitted to, and each of the plurality of arithmetic devices may comprise means for determining which of a plurality of partial data items received from the plurality of data input devices a predetermined arithmetic operation is to be performed on.

This allows each data input device itself to choose a destination arithmetic device and allows each arithmetic device itself to pick out partial data items to be included as the subject of the statistical processing, which can prevent the data processing device not only from acquiring the contents of each original data item but from dealing with information on each original data item, achieving a higher level of data security.

In either of the configurations described above, the number of the plurality of arithmetic devices may be equal to or larger than a predetermined number that is the number of partial data items to be obtained from one original data item, and the predetermined number of partial data items may be separately transmitted to arithmetic devices different from one another.

In the system described above, the plurality of arithmetic devices may separately belong to services provided by providers different from one another, and the data processing device may be operated by a provider different from those of the plurality of arithmetic devices.

This allows, for example, a provider implementing the statistical processing to administer the data processing device and use data storage and arithmetic operation services provided by a plurality of existing cloud service providers to perform a statistical processing result provision service.

A server device for providing a statistical processing result of one example according to the principle of the invention is for a service that provides a result of statistical processing based on a plurality of original data items without acquiring the original data items to be hidden, and comprises: means for communicating with a plurality of arithmetic devices, each having means for performing a predetermined arithmetic operation based on a plurality of input data items; means for causing each of the plurality of arithmetic devices to perform an arithmetic operation using partial data items as the input data items, each partial data item being a part of the original data item, and acquiring a result of the arithmetic operation; and means for performing predetermined statistical processing based on arithmetic results obtained from the plurality of arithmetic devices. The plurality of partial data items are generated by dividing the original data item in accordance with a secret ratio where adding up all the partial data items restores the original data item.

This configuration prevents any of the arithmetic devices and server device from acquiring original data since the original data is converted to partial data items and they are passed to the plurality of arithmetic devices in a distributed manner. Accordingly, this avoidance of holding the original data allows for reducing the risk of leakage of information to be hidden. On the other hand, a result of statistical processing for a set of original data items can be obtained since the server device causes the plurality of arithmetic devices to perform the arithmetic operation with the partial data items being used as the input and uses the result. The secrecy of the original data can be maintained since the original data is not restored even if a third party acquires part of the partial data items. The secret ratio exists only in a device that divides the original data and at least during the division, and can be known to nobody or only to the holder of the original data.

The server device described above may further comprise: means for verifying with the plurality of arithmetic devices that all partial data items that belong to the original data item are inputted; and means for instructing each of the plurality of arithmetic devices that the predetermined arithmetic operation is to be performed on each of the partial data items for which the verification is done in the corresponding arithmetic device.

This allows for eliminating from the arithmetic operation partial data items that cause an erroneous result or the like if included as the subject of the statistical processing. For example, when one partial data item belonging to an original data item is received by and stored in the corresponding arithmetic device but another partial data item belonging to the same original data is not received by the corresponding arithmetic device and if each arithmetic device performs the arithmetic operation on all partial data items stored in itself, then the result of processing the arithmetic results obtained from those arithmetic devices will be erroneous. However, a correct statistical processing result can be obtained if the server device collectively using the plurality of arithmetic devices notifies each arithmetic device of those whose partial data items are completely gathered.

The server device in the configuration described above may further comprise means for receiving from each of the plurality of arithmetic devices, for the verification, an identification number of an original data item to which partial data items stored in the relevant arithmetic device belong.

This allows the server device to verify whether partial data items are completely gathered or not surveying the plurality of arithmetic devices without acquiring individual partial data items from each arithmetic device.

The server device in the configuration described above may further comprise: means for notifying the plurality of arithmetic devices of a set of identification numbers of original data items for which the verification is done as being related to a sequence number; and means for notifying the plurality of arithmetic devices of a set of identification numbers of original data items for which the verification is done after a previous notification as being related to a next sequence number, and by transmitting to each of the plurality of arithmetic devices an instruction for the predetermined arithmetic operation as well as designation of one sequence number, partial data items that are to be subject to the predetermined arithmetic operation may be determined with sets of identification numbers corresponding to a plurality of sequence numbers including the designated and preceding sequence numbers.

This allows the server device to cause each arithmetic device to share information on which partial data items of multiple partial data items held by each arithmetic device are completely gathered or not any time while multiple partial data items are received by and accumulated in each arithmetic device.

The server device in the configuration described above may further comprise means for forbidding, after acquiring a result of the predetermined arithmetic operation which the plurality of arithmetic devices are caused to perform on a set of original data items, to acquire a result of the predetermined arithmetic operation which the plurality of arithmetic devices are caused to perform on the set of original data items added with a limited number of original data items.

The server device, as described above, receives results of the arithmetic operation performed on N partial data items from each of M arithmetic devices and processes them, thereby obtaining a result of statistical processing for N original data items. Therefore, if a statistical processing result is obtained from original data items for i=1, N at a point in time, if a statistical processing result is obtained from original data items for i=1, . . . , N, N+1 at the next point in time, and if the difference between the two is determined, an original data item for i=N+1 can be determined.

Forbidding to acquire an arithmetic result at such a point in time allows for ensuring that the server device is prevented from doing a malicious operation such as substantially acquiring individual partial data items from each arithmetic device to restore the original data.

The server device described above may further comprise: means for communicating with a plurality of data input devices, each having means for acquiring the original data item and generating the partial data items; means for choosing from among available arithmetic devices the plurality of arithmetic devices for performing the predetermined statistical processing; and means for notifying each of the plurality of data input devices of information on the plurality of arithmetic devices such that the partial data items can be transmitted to the chosen plurality of arithmetic devices.

This allows for choosing arithmetic devices to be used, in each case, depending on what is to be obtained from the statistical processing as a result, also allows the destination of the partial data items to be uniquely set by notification from the server device even if the number of data input devices is large, and therefore simplifies the administration.

A data input device of one example according to the principle of the invention comprises: means for acquiring an original data item to be hidden; means for generating a predetermined number of partial data items by dividing the original data item in accordance with a secret ratio where adding up all the partial data items restores the original data item; and means for transmitting each of the predetermined number of partial data items to a corresponding one of a plurality of arithmetic devices, each having means for performing a predetermined arithmetic operation based on a plurality of input data items, through a protected communication channel as one of the plurality of input data items. By a server device different from the plurality of arithmetic devices using a result of the predetermined arithmetic operation performed by each of the plurality of arithmetic devices based on partial data items from a plurality of data input devices, a result of statistical processing based on a plurality of original data items acquired by the plurality of data input devices is obtained with the original data items being hidden.

This configuration allows for reducing the risk of leakage of original data to be hidden, and at the same time allows for obtaining a result of statistical processing for a set of original data items since the server device causes the plurality of arithmetic devices to perform the arithmetic operation with the partial data items being used as the input and uses the result.

The data input device described above may further comprise: means for causing the transmitted predetermined number of partial data items to be stored in their respective corresponding arithmetic devices as being able to be accessed only by a permitted person; and means for erasing the memory of the acquired original data item, and the original data item may be restored based on the predetermined number of partial data items acquired from their respective arithmetic devices by the permitted person.

This allows the primary holder to be provided for the future acquisition of the original data not by storing the original data in the data input device but by allowing partial data items stored in a plurality of arithmetic devices in a distributed manner to be acquired to restore the original data, and therefore can surely reduce the risk of leakage of information to be hidden.

The data input device described above may further comprise: means for storing information for access to the server device; and means for receiving information for identifying the corresponding arithmetic device from the server device.

This allows the data input device to determine how the partial data items are generated by dividing the original data into how many items and are passed to which plurality of arithmetic devices, or the like, in accordance with instructions given by the server device as long as the data input device stores information for access to the server device.

The data input device described above may further comprise: means for assigning identification information unique in a system to the partial data items; and means for identifying the corresponding arithmetic device in accordance with which of the scopes separately covered by the respective arithmetic devices a value determined based on the identification information belongs to.

This allows the data input device to determine by itself a destination arithmetic device to which each partial data item is sent, so that the server device can avoid dealing with information on each original data item and partial data items obtained from one original data item can also be transmitted to their own arithmetic devices different from one another, achieving a higher level of data security.

The data input device described above may further comprise means for, after verifying that for all partial data items obtained from one original data item, each partial data item has been received by any arithmetic device, transmitting information indicating that the verification is successful to one arithmetic device and registering the information.

This configuration and the configuration of each arithmetic device illustrated below allow for eliminating from the arithmetic operation partial data items, of partial data items held by each arithmetic device, that cause an erroneous result or the like if included as the subject of the statistical processing.

An arithmetic device of one example according to the principle of the invention comprises: means for communicating with a server device for a service that provides a result of statistical processing based on a plurality of original data items without acquiring the original data items to be hidden; means for receiving partial data items belonging to each of a plurality of original data items from a plurality of data input devices, each having means for hiding an original data item therein; and means for performing a predetermined arithmetic operation based on a plurality of input data items. The server device performs predetermined statistical processing based on arithmetic results obtained from a plurality of arithmetic devices, and the arithmetic device further comprises: means for choosing, as the input data items, those among a plurality of partial data items received from the plurality of data input devices as to which information is registered, the information indicating that it is verified that for all partial data items obtained from one original data item, each partial data item has been received by any arithmetic device; and means for transmitting to the server device a result of the predetermined arithmetic operation performed on the chosen input data items.

The configurations described above may be realized as any of an invention of the data-hidden statistical processing system, an invention of the server device for providing a statistical processing result, and an invention of the data input device described above, and such inventions may also be realized as a method performed by the whole present system or each individual device, a program for causing a general purpose computer system to operate as the whole present system (or a recording medium on which such program is recorded), or a program for causing a general purpose computer to operate as each individual device (or a recording medium on which such program is recorded). Some of them are illustrated below.

A program of one example according to the principle of the invention is for causing a computer having a function to communicate with other computers to operate as a data processing device in a data-hidden statistical processing system. As the other computers there are a plurality of arithmetic devices, each having means for performing a predetermined arithmetic operation based on a plurality of input data items, and the data processing device provides a result of statistical processing based on a plurality of original data items without acquiring the original data items to be hidden. The program causes the computer to comprise: means for causing each of the plurality of arithmetic devices to perform an arithmetic operation using partial data items as the input data items, each partial data item being a part of the original data item, and acquiring a result of the arithmetic operation; and means for performing predetermined statistical processing based on arithmetic results obtained from the plurality of arithmetic devices, and the plurality of partial data items are generated by dividing the original data item in accordance with a secret ratio where adding up all the partial data items restores the original data item.

A program of another example according to the principle of the invention is for causing a computer having functions to acquire an original data item to be hidden and to communicate with other computers to operate as a data input device in a data-hidden statistical processing system. As the other computers there are a plurality of arithmetic devices, each having means for performing a predetermined arithmetic operation based on a plurality of input data items. The program causes the computer to comprise: means for generating a predetermined number of partial data items by dividing the original data item in accordance with a secret ratio where adding up all the partial data items restores the original data item; and means for transmitting each of the predetermined number of partial data items to a corresponding one of the plurality of arithmetic devices through a protected communication channel as one of the plurality of input data items, and by a server device different from the plurality of arithmetic devices using a result of the predetermined arithmetic operation performed by each of the plurality of arithmetic devices based on partial data items from a plurality of data input devices, a result of statistical processing based on a plurality of original data items acquired by the plurality of data input devices is obtained with the original data items being hidden.

A program of still another example according to the principle of the invention is for causing a computer having a function to communicate with other computers to operate as one of a plurality of arithmetic devices in a data-hidden statistical processing system.

As the other computers there are: a server device for a service that provides a result of statistical processing based on a plurality of original data items without acquiring the original data items to be hidden; and a plurality of data input devices, each having means for hiding the original data item therein. The program causes the computer to comprise: means for receiving partial data items belonging to each of a plurality of original data items from a plurality of data input devices; means for performing a predetermined arithmetic operation based on a plurality of input data items; means for choosing, as the input data items, those among a plurality of partial data items received from the plurality of data input devices as to which information is registered, the information indicating that it is verified that for all partial data items obtained from one original data item, each partial data item has been received by any arithmetic device; and means for transmitting to the server device a result of the predetermined arithmetic operation performed on the chosen input data items, and the server device performs predetermined statistical processing based on arithmetic results obtained from the plurality of arithmetic devices.

In a service method for providing a statistical processing result of one example according to the principle of the invention, each of a plurality of data input devices comprising means for acquiring an original data item to be hidden outputs a predetermined number of partial data items obtained by dividing the original data item in accordance with a secret ratio where adding up all the partial data items restores the original data item, each of a plurality of arithmetic devices comprising means for performing a predetermined arithmetic operation based on a plurality of input data items outputs a result of the arithmetic operation performed using partial data items as the input data items, each partial data item being outputted from each of a plurality of data input devices, and a data processing device uses the arithmetic operation results, each result being outputted from each of the plurality of arithmetic devices, thereby obtaining a statistical processing result based on a plurality of original data items acquired by the plurality of data input devices without acquiring the original data items.

Now, embodiments of the invention will be described, by way of example, with reference to the drawings. The present system is for performing cloud-based data processing that takes privacy protection into account.

Currently, many sensors and IC cards are popular. There are an enormous number of data generation sources (those that can be data input devices in the present system), such as hundreds of millions of cars, over a billion of smartphones, and billions to trillions of sensors. A variety of M2M (Machine to Machine) services for them have been devised.

It is assumed that most of these services perform data accumulation and analysis processes by using a cloud whose resources are provided by a third party other than the primary holder of the data. This means that the data handled in the cloud includes large amounts of privacy information, increasing the risk of information leakage at the time when the data leaks out of the cloud. For this reason, it is highly desired for the use of a cloud that data in the cloud is kept hidden throughout in the cloud from the accumulation to analysis processes of the data in order to reduce the risk of information leakage.

The present system therefore performs division that can hide original data (hereinafter sometimes referred to as “secret division”) when gathering the original data from data generation sources. The original data is not passed to anywhere, but its divided data items are passed to a plurality of clouds for accumulation and analysis processes. This prevents the original data from being restored from some data leaked from a single cloud.

In the present system, statistical analysis processes are performed separately in each cloud, and an analysis provider (also referred to as a “statistical processing result provision service provider”) other than the clouds gathers processing results from the clouds to obtain a result of original statistical processing. In this regard, providers that provide the cloud services are preferably separate providers in order to reduce the probability of data leaking at once from the plurality of clouds and also to prevent them from trying to derive the original data by summing the data items in the plurality of clouds. Which cloud service to use may be determined by the analysis provider or holders of the data generation sources.

Since computational resources can be temporarily used in cloud services, a cloud service may be used to secure necessary computational resources as needed and free the computational resources no longer required after an arithmetic process (erase all partial data items stored for the arithmetic process) when the present system is to be applied to a case where it is not required to store data permanently (it is not required to restore original data). This can increase security against information leakage, and can additionally eliminate the need to maintain physically redundant computational resources.

The analysis provider may be different from holders of data generation sources, or may be a company itself that holds data generation sources if, for example, the one company uses a third-party cloud service to accumulate and analyze data generated from multiple data generation sources held by the company itself. There may be an application in which holders of data generation sources are individuals who are different from one another and are also different from the analysis provider and a user company which is provided with a statistical processing result by the analysis provider.

The present system can execute processing to determine the sum, sum of squares, inner product, or the like of multiple original data items while performing secret division on the original data items and keeping them distributed in a plurality of clouds as described above. For example, average value and variance can be determined or basic estimation and tests can be performed as statistical processing if just the sum and the sum of squares can be determined, so there may be various applications. In addition, the security can be increased sufficiently since original data is made to exist nowhere and a statistical processing result can be obtained with the original data being divided in a secret manner and with a plurality of data items generated from one original data item by the secret division not being gathered in one place but being distributed.

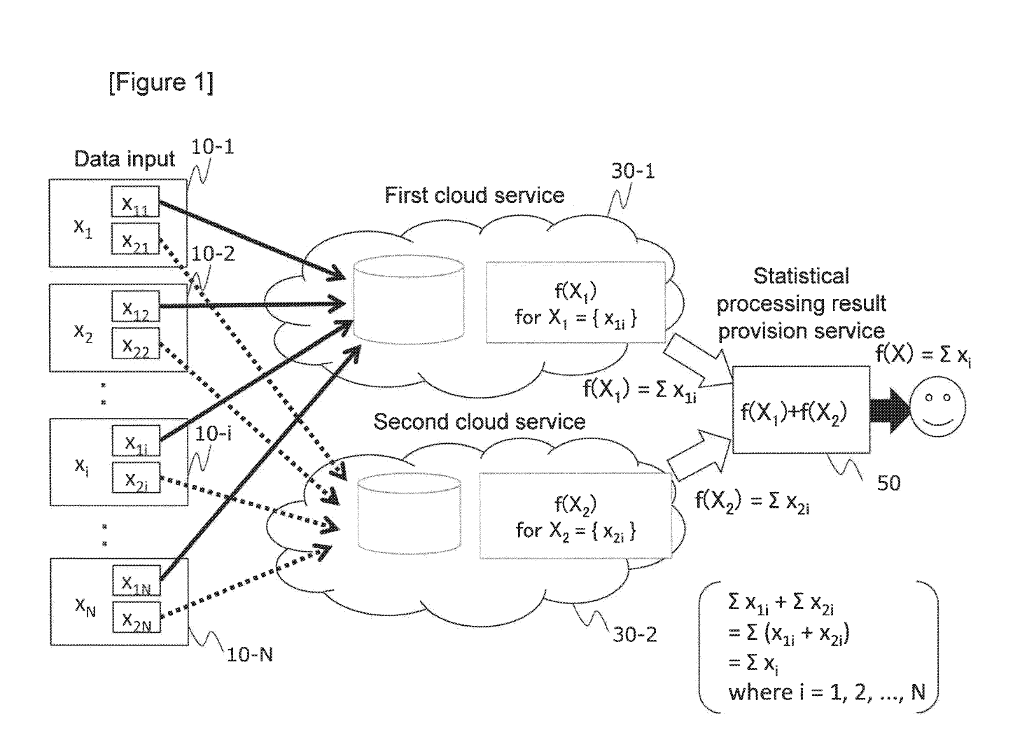

FIG. 1 shows an example of the present system in which each original data item is divided into two to determine the sum of N original data items. Though in the figure data input devices 10-1 to 10-N are described to divide their respective original data items x₁ to x_{N} and upload them to cloud service facilities 30-1 and 30-2 for illustrative purposes, one data input device can perform acquisition, secret division, and uploading on a plurality of original data items, of course, in the present system. N is an integer greater than or equal to two, and can be a number on the order of hundreds of millions or trillions.

Upon acquiring an original data item each data input device 10-i divides xᵢ to satisfy xᵢ=x₁ᵢ+x₂ᵢ. The ratio for the division is determined for each division on a random basis by generating a random number in the device or the like, and is kept secret (this process is called “secret division by random share”).

This allows each x₁ᵢ and x₂ᵢ to be perfectly secure about xᵢ (this is expressed as “H(xᵢ|x₁ᵢ)=H(xᵢ) & H(xᵢ|x₂ᵢ)=H(xᵢ)”). This ensures that original data cannot be restored with data leaked from a single cloud.

Each data input device 10-i then uploads the partial data item to the first cloud service facility 30-1 and uploads the partial data item x₂ᵢ to the second cloud service facility 30-2. Each cloud service facility 30-j stores the uploaded data items. The uploading from each data input device may be done anytime at their own timing, and at a point in time a state is reached in which N partial data items {x₁₁, x₁₂, . . . , x_{1N}} are stored in the first cloud service facility 30-1 and N partial data items {x₂₁, x₂₂, . . . , x_{2N}} are stored in the second cloud service facility 30-2.

At this point in time, the first cloud service facility 30-1 calculates the sum of the N partial data items x₁ᵢ and transmits the result f(X₁) to a statistical processing result provision server 50, and the second cloud service facility 30-2 calculates the sum of the N partial data items x₂ᵢ and transmits the result f(X₂) to the statistical processing result provision server 50. The capability to use calculator resources in the clouds for the process is a significant advantage when N is a huge number.

The statistical processing result provision server 50 determines the sum of the transmitted results. This means that the sum of the original data items xᵢ is determined, since the value of “f(X₁)+f(X₂)” equals the value of the sum of (x₁ᵢ+x₂ᵢ) for i=1 to N. A user of the service provided by the present system sees only the result of the statistical analysis.

Since the statistical processing result provision server 50 acquires only f(Xᵢ), the result of the calculation process performed on the N partial data items, from each cloud, and has no concern with individual partial data items, a high secrecy of the original data can be maintained against the analysis provider that operates the statistical processing result provision server 50.

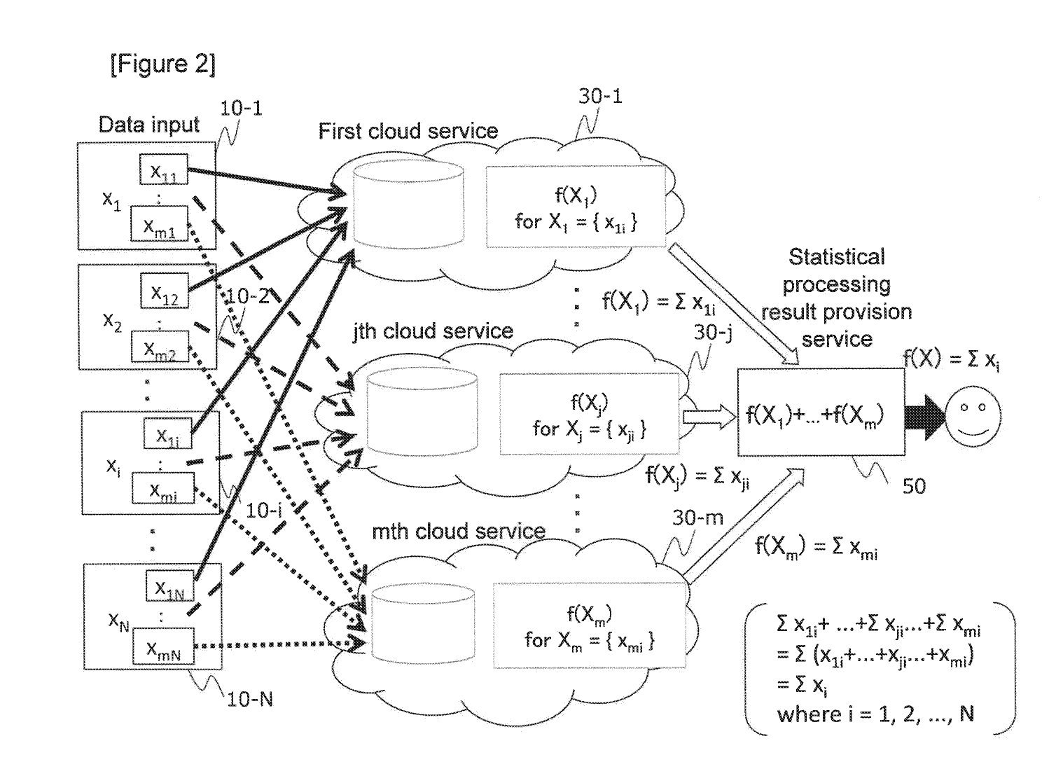

While FIG. 1 is the example in which each original data item is divided into two, FIG. 2 shows an example of the present system in which each original data item is divided into m (a number greater than two) and the sum of N original data items is determined. The process in FIG. 2 is performed in m independent and different clouds in a distributed manner.

Upon acquiring an original data item xᵢ, each data input device 10-i divides xᵢ to satisfy xᵢ=x₁ᵢ+x₂ᵢ+ . . . +xₘᵢ. The ratio for the division is determined for each division on a random basis by generating a random number in the device or the like, and is kept secret.

This secret division by random share causes individual x₁ᵢ, x₂ᵢ, . . . , xₘᵢ to be perfectly secure about xᵢ, and the secrecy is maintained even if data items leak from (m−1) places at the same time, since, for example, xᵢ cannot be restored if the values of x₁ᵢ to x₍ₘ₋₁₎, are known but the value of xₘᵢ is unknown.

Each data input device 10-i then uploads to each of m cloud service facilities 30-j the corresponding partial data item xⱼᵢ. The uploading may be done individually for each data input device at their own timing, and at a point in time a state is reached in which N partial data items {xⱼ₁, xⱼ₂, . . . , x_{jN}} are stored in every cloud service facility 30-j.

At this point in time, each cloud service facility 30-j calculates the sum of the N partial data items xⱼᵢ and transmits the result f(Xⱼ) to the statistical processing result provision server 50. The statistical processing result provision server 50 determines the sum of the transmitted results. This means that the sum of the original data items xᵢ is determined, since the value of “f(X₁)+f(X₂)+ . . . +f(Xₘ)” equals the value of the sum of (x₁ᵢ+x₂ᵢ+xₘᵢ) for i=1 to N.

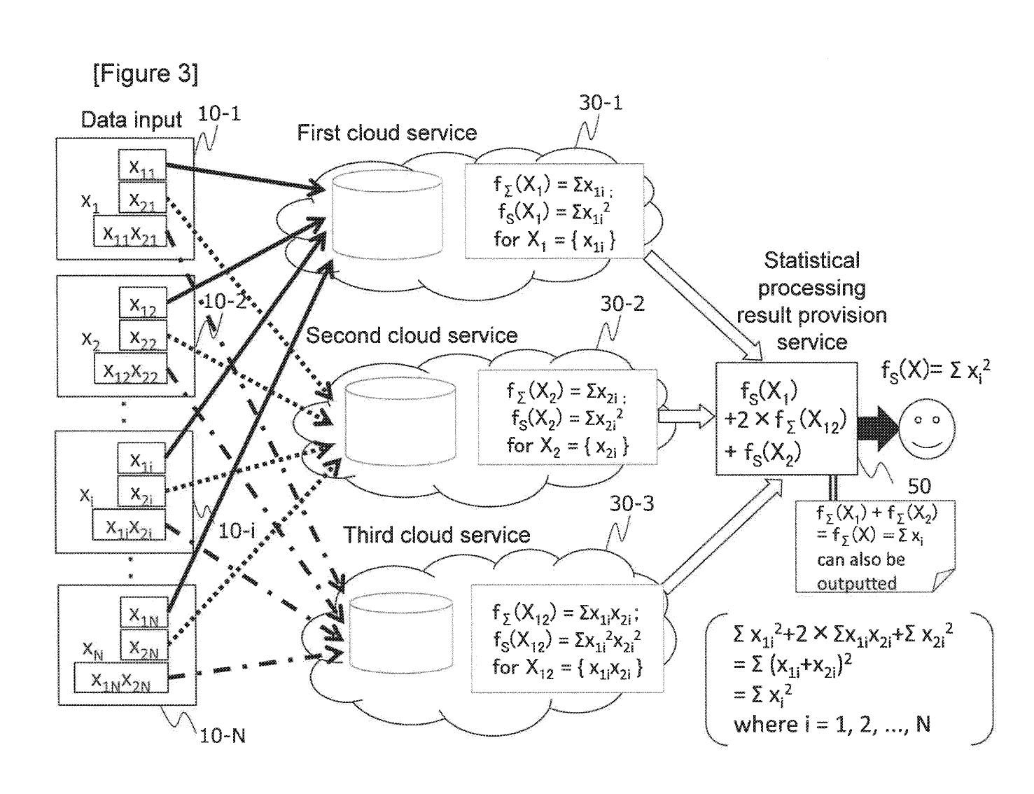

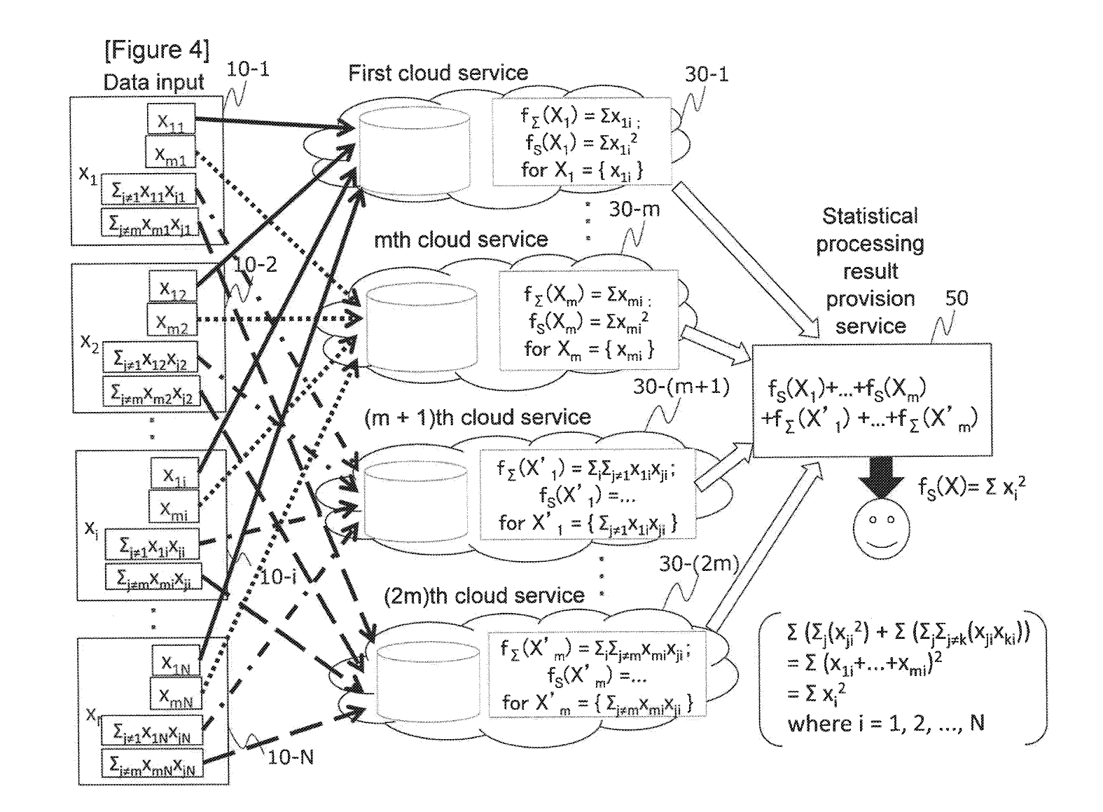

FIG. 3 shows an example of the present system in which each original data item is divided into two to determine the sum of squares of N original data items. While the process to determine the sum of xᵢ for i=1 to N is described as f(Xᵢ) in FIG. 1, the process to determine the same sum is expressed as f_{Σ}(Xᵢ) and the process to determine the sum of squares of xᵢ for i=1 to N is described as f_{S}(Xᵢ) in FIGS. 3 and 4.

While FIG. 3 illustrates a case in which the statistical processing result provision server 50 determines the sum of squares of N original data items, f_{S}(X), using the sum of squares f_{S}(X₁) from a first cloud service facility 30-1, the sum of squares f_{S}(X₂) from a second cloud service facility 30-2, and the sum f_{Σ}(X₁₂) from a third cloud service facility 30-3, the sum of the N original data items, f_{Σ}(X), can also be determined at the same time by using the sum f_{Σ}(X₁) from the first cloud service facility 30-1 and the sum f_{Σ}(X₂) from the second cloud service facility 30-2.

Upon acquiring an original data item xᵢ, each data input device 10-i performs secret division by random share, so that xᵢ is divided to satisfy xᵢ=x₁ᵢ+x₂ᵢ. When the sum of squares is to be determined as a statistical processing result, each data input device 10-i further determines the value of x₁ᵢ and x₂ᵢ multiplied by each other, and generates three items x₁ᵢ, x₂ᵢ, and x₁ᵢx₂ᵢ as partial data items of xᵢ. The statistical processing result provision server 50 may instruct each data input device 10-i whether to generate and upload also x₁ᵢx₂ᵢ as in FIG. 3 or just x₁ᵢ and x₂ᵢ as in FIG. 1.

Each data input device 10-i then uploads the partial data item x₁ᵢ to the first cloud service facility 30-1, uploads the partial data item x₂ᵢ to the second cloud service facility 30-2, and uploads the partial data item x₁ᵢx₂ᵢ to the third cloud service facility 30-3. In this case, the original data is not restored even if data leaks from one of the three clouds.

Each cloud service facility 30-j stores the uploaded data items. The uploading from each data input device may be done anytime at their own timing, and at a point in time a state is reached in which: N partial data items {x₁₁, x₁₂, . . . , x_{1N}} are stored in the first cloud service facility 30-1; N partial data items {x₂₁, x₂₂, . . . , x_{2N}} are stored in the second cloud service facility 30-2; and N partial data items {x₁₁x₂₁, x₁₂x₂₂, . . . , x_{1N}x_{2N}} are stored in the third cloud service facility 30-3.

At this point in time, the first cloud service facility 30-1 calculates the sum and the sum of squares of the N partial data items x₁ᵢ and transmits the respective results f_{Σ}(X₁) and f_{S}(X₁) to the statistical processing result provision server 50, the second cloud service facility 30-2 calculates the sum and the sum of squares of the N partial data items x₂ᵢ and transmits the respective results f_{Σ}(X₂) and f_{S}(X₂) to the statistical processing result provision server 50, and the third cloud service facility 30-3 calculates the sum and the sum of squares of the N partial data items x₁ᵢx₂ᵢ and transmits the respective results f_{Σ}(X₁₂) and f_{S}(X₁₂) to the statistical processing result provision server 50.

The statistical processing result provision server 50 chooses f_{S}(X₁), f_{S}(X₂), and f_{Σ}(X₁₂) from the transmitted results and, after multiplying f_{Σ}(X₁₂) by two, determines the sum of all these items. This means that the sum of the original data items xᵢ² (i.e. the sum of squares of xᵢ) is determined, since the value of “f_{S}(X₁)+2f_{Σ}(X₁₂)+f_{S}(X₂)” equals the value of the sum of (x₁ᵢ+x₂ᵢ)² for i=1 to N.

In the configuration in FIG. 3, the sum of the original data xᵢ can be determined if the statistical processing result provision server 50 chooses f_{Σ}(X₁) and f_{Σ}(X₂) from the transmitted results and determines the sum of them. The result f_{S}(X₁₂) from the third cloud is not used in both cases, and the results f_{Σ}(Xⱼ) from the first and second clouds are not used when only the sum of squares is to be determined. When only the sum is to be determined in the configuration in FIG. 3, the results f_{S}(Xⱼ) from the first and second clouds are not used and any result from the third cloud is not used.

Though the calculation process whose results are not used could be regarded as the waste of resources, there are abundant calculator resources in the clouds, and the standardization of the calculation process in every cloud independent of details of the statistical processing to be performed by the statistical processing result provision server 50 has the following advantage.

In the configuration in FIG. 3, each cloud service facility 30-j has no concern with whether uploaded data item is a partial one xⱼᵢ into which xᵢ is divided or xⱼᵢxₖᵢ which is the product of two items and, furthermore, even with whether it is an original data item or a partial data item, but simply and uniformly performs the process to calculate the sum and the sum of squares on input data items for i=1 to N. For this reason, details of the statistical processing performed by the statistical processing result provision server 50, meanings of data stored in each cloud, and the like will not be guessed from details of the calculation process performed in each cloud, and the security can be further increased.

While FIG. 3 is the example in which each original data item is divided into two, FIG. 4 shows an example of the present system in which each original data item is divided into m (a number greater than two) and the sum of squares of N original data items is determined. The process in FIG. 4 is performed in 2m independent and different clouds in a distributed manner. In this case, the original data is not restored even if data leaks from (m−1) of the 2m clouds.

Upon acquiring an original data item xᵢ, each data input device 10-i performs secret division by random share, so as to divide xᵢ to satisfy xᵢ=x₁ᵢ+x₂ᵢ+ . . . +xₘᵢ. First, each data input device 10-i generates m partial data items xⱼᵢ (j=1, 2, . . . , m).

Each data input device 10-i further generates m partial data items x′ⱼᵢ (j=1, 2, . . . , m), where x′ⱼᵢ is the value of xⱼᵢ and the value of the sum of xₖᵢ other than x₁ᵢ multiplied by each other. For example, if m=4, each data input device 10-i generates x′₁ᵢ=x₁ᵢx₂ᵢ+x₁ᵢx₃ᵢ+x₁ᵢx₄ᵢ, x′₂ᵢ=x₂ᵢx₁ᵢ+x₂ᵢx₃ᵢ+x₂ᵢx₄ᵢ, x′₃ᵢ=x₃ᵢx₁ᵢ+x₃ᵢx₂ᵢ+x₃ᵢx₄ᵢ, and x′₄ᵢ=x₄ᵢx₁ᵢ+x₄ᵢx₂ᵢ+x₄ᵢx₃ᵢ.

Each data input device 10-i then uploads to each of m cloud service facilities 30-j (j=1, 2, . . . , m) the corresponding partial data item xⱼᵢ, and further uploads to each of m cloud service facilities 30-j (j=m+1, m+2, . . . , m+m) the corresponding partial data item x′ⱼᵢ. The uploading may be done individually for each data input device at their own timing, and at a point in time a state is reached in which N partial data items for i=1 to N are stored in every cloud service facility 30-j.

At this point in time, each cloud service facility 30-j calculates the sum and the sum of squares of the N partial data items (xⱼᵢ for j=1 to m and x′ⱼᵢ for j=m+1 to 2m, but each cloud has no concern with the difference between them) and transmits the respective results (f_{Σ}(Xᵢ) and f_{S}(Xᵢ) for j=1 to m, and f_{Σ}(X′ᵢ) and f_{S}(X′ᵢ) for j=m+1 to 2m, but each cloud has no concern with the difference between them) to the statistical processing result provision server 50.

The statistical processing result provision server 50 chooses, from the transmitted results, f_{S}(Xᵢ) as for the results from clouds for j=1 to m and f_{Σ}(X′ᵢ) as for the results from clouds for j=m+1 to 2m, and determines the sum of all these items. This means that the sum of the original data items xᵢ² (i.e. the sum of squares of xᵢ) is determined, since the value of “f_{S}(X₁)+f_{S}(X₂)+ . . . +f_{S}(Xₘ)+f_{Σ}(X′₁)+f_{Σ}(X′₂)+ . . . +f_{Σ}(X′ₘ)” equals the value of the sum of (x₁ᵢ+x₂ᵢ+ . . . +xₘᵢ)² for i=1 to N.

Both the sum and the sum of squares of the original data items xᵢ can be determined also in the configuration in FIG. 4 as in FIG. 3. Out of the results outputted from the clouds, f_{Σ}(Xᵢ) from clouds for j=1 to m are used for the sum, and f_{S}(Xᵢ) from clouds for j=1 to m and f_{Σ}(X′ᵢ) from clouds for j=m+1 to 2m are used for the sum of squares.

Once the sum and the sum of squares are obtained as described above, they can be broadly applied to basic statistical analysis techniques as illustrated below.

The sample mean m can be determined as m=σ/N=f_{Σ}(X)/N, and maximum likelihood can be estimated for a population by assuming the maximum likelihood mean value=m if the population is normally distributed.

The sample variance s² can be determined as s²=(S−σ²)/N=(f_{S}(X)−{f_{Σ}(X)}²)/N, and the standard deviation s can be determined as the positive square root of the sample variance s².

As for interval estimation using the t distribution, since T=(m−μ)(s/N^{1/2}) is t distributed with (N−1) degrees of freedom, a 95% confidence interval for the population mean μ can be estimated as m−1.96×s/N^{1/2}≦μ≦m+1.96×s/N^{1/2}, for example. This allows the population mean to be estimated.

As for estimation of a confidence interval for population proportion, if the sample proportion r (e.g. r out of N persons answered YES) is determined as r=f_{Σ}(X), a 95% confidence interval for the population proportion R can be estimated as follows.

r−1.96×(r(1−r)/N)^{1/2}≦R≦r+1.96×(r(1−r)/N)^{1/2}

This is applicable to YES/NO or closed question (or machine on/off) statistical data.

As for estimation of population variance, if a population is normally distributed with the variance σ² and the unbiased variance for N samples is s², then Z=(N−1)×s²/σ² is χ² distributed with (N−1) degrees of freedom, and therefore the relation among the population variance σ² and the distribution's lower 95% point k₁ and upper 95% point k₂ can be estimated as follows.

(N−1)×s²/k₂≦σ²≦(N−1)×s²/k₁

This allows the dispersion of the population to be estimated.

A test for population mean (t test) can be done by using the fact that T=(m−μ)/(s/N^{1/2}) is t distributed with (N−1) degrees of freedom. A test for the population mean difference between populations A and B can be done by using the fact that T=(m_{A}−m_{B})/(Z₁^{1/2}×Z₂^{1/2}) is t distributed with (N_{A}+N_{B}−2) degrees of freedom, where

Z₁=1/N_{A}+1/N_{B}, and

Z₂=((N_{A}−1)×s_{A}²+(N_{B}−1)×s_{B}²)/(N_{A}N_{B}−2).

This allows the population mean to be tested.

A test for population proportion (χ² test) can be done by using the fact that χ²=(N−1)×s²/σ² is χ² distributed with (N−1) degrees of freedom. A comparison test for population variances of populations A and B (F test) can be done by using the fact that F=s_{A}²/s_{B}² is F distributed with N_{A}−1 and N_{B}−1 degrees of freedom, since F=(s_{A}²/σ_{A}²)/(s_{B}²/σ_{B}²) is F distributed with k_{A} and k_{B} degrees of freedom and given that the population variances are the same. This allows the dispersion of the population to be tested.

One-way analysis of variance can be done for the purpose of, for example, examining whether measures 1, 2, . . . , k work differently or not, and can be done by using the fact that F=Q₁/Q₂ is F distributed with (k−1) and k×(N−1) degrees of freedom, where the overall mean is m=ΣᵢΣⱼxᵢⱼ/N (where N=ΣᵢNᵢ), the group mean is mᵢ=Σⱼxᵢⱼ/Nᵢ, the between-group variation is Qᵢ=Σᵢ(mᵢ−m)², and the within-group variation is Q₂=ΣᵢΣⱼ(xᵢⱼ−mᵢ)². This is effective, for example, for confirming the efficacy of measures, medication, renovations, improvement, campaigns, advertisements, or other approaches.

Two-way analysis of variance can be done for both cases with and without replication based on a simple expansion of the above-described one-way analysis of variance. This is effective for confirming the efficacy of a combination of a plurality of approaches.

While there has been described statistical analysis of one factor, the present system can be applied to statistical analysis of a plurality of factors. For example, the present system can determine, as application to two-factor cases, an inner product, covariance, and a coefficient of correlation, and additionally a regression equation, a coefficient of determination, or the like.

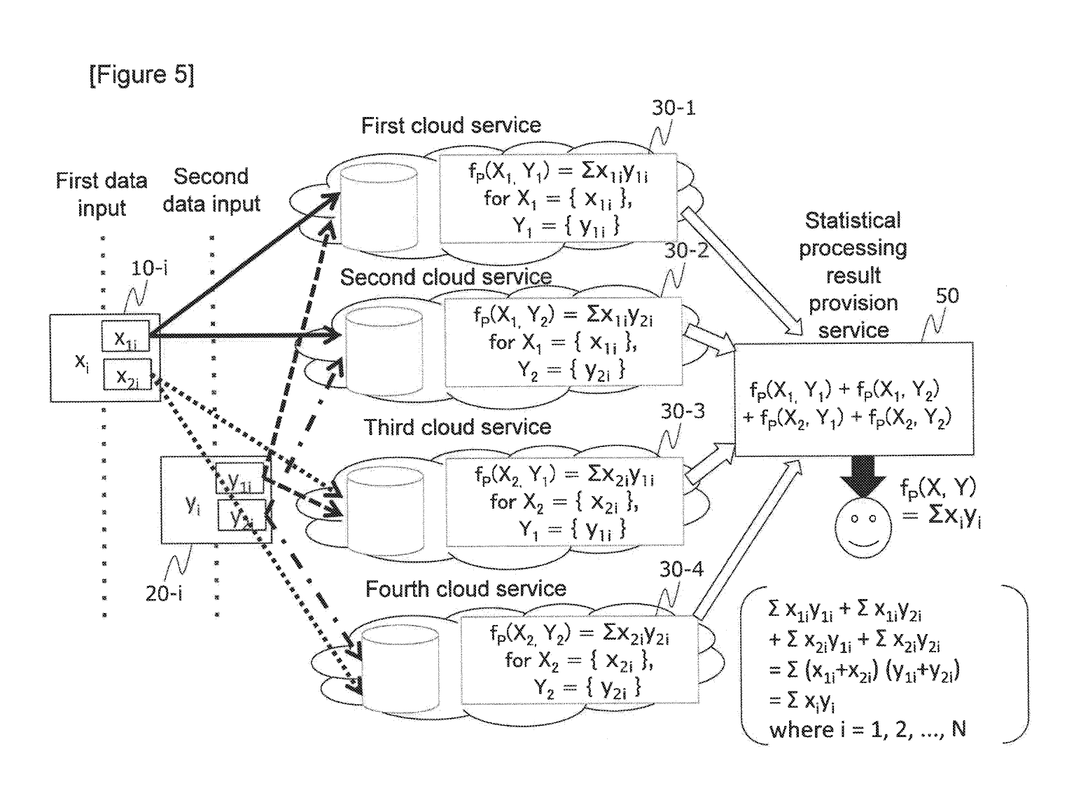

FIG. 5 shows an example of the present system in which each of two-factor original data items xᵢ and yᵢ is separately divided into two to determine the inner product of N pairs of original data items. While FIG. 5 is an example in which each original data item is divided into two, the inner product of N pairs of original data items can also be determined, of course, by dividing each original data item into m (greater than 2) and processing them in m² independent and different clouds in a distributed manner.

Each data input device 10-i that acquires original data items xᵢ belonging to the first factor performs secret division by random share, so that xᵢ is divided to satisfy xᵢ=x₁ᵢ+x₂ᵢ. Each data input device 20-i that acquires original data items yᵢ belonging to the second factor performs secret division by random share, so that yᵢ is divided to satisfy yᵢ=y₁ᵢ+y₂ᵢ.

Then, each data input device 10-i uploads the partial data item x₁ᵢ to the first and second cloud service facilities 30-1 and 30-2 and uploads the partial data item x₂ᵢ to the third and fourth cloud service facilities 30-3 and 30-4, and each data input device 20-i uploads the partial data item y₁ᵢ to the first and third cloud service facilities 30-1 and 30-3 and uploads the partial data item y₂ᵢ to the second and fourth cloud service facilities 30-2 and 30-4.

Each cloud service facility 30-j stores the uploaded data items. The uploading from each data input device may be done anytime at their own timing, and at a point in time a state is reached in which: N partial data items {x₁₁, x₁₂, . . . , x_{1N}} of the first factor and N partial data items {y₁₁, y₁₂, . . . , y_{1N}} of the second factor are stored in the first cloud service facility 30-1; N partial data items {x₁₁, x₁₂, . . . , x_{1N}} of the first factor and N partial data items {y₂₁, y₂₂, . . . , y_{2N}} of the second factor are stored in the second cloud service facility 30-2; N partial data items {x₂₁, x₂₂, . . . , x_{2N}} of the first factor and N partial data items {y₁₁, y₁₂, y_{1N}} of the second factor are stored in the third cloud service facility 30-3; and N partial data items {x₂₁, x₂₂, . . . , x_{2N}} of the first factor and N partial data items {y₂₁, y₂₂, y_{2N}} of the second factor are stored in the fourth cloud service facility 30-4.

At this point in time, the first cloud service facility 30-1 calculates the inner product of the N pairs of partial data items x₁ᵢ and y₁ᵢ and transmits the result f_{P}(X₁, Y₁) to the statistical processing result provision server 50, the second cloud service facility 30-2 calculates the inner product of the N pairs of partial data items x₁ᵢ and y₂ᵢ and transmits the result f_{P}(X₁, Y₂) to the statistical processing result provision server 50, the third cloud service facility 30-3 calculates the inner product of the N pairs of partial data items x₂ᵢ and y₁ᵢ and transmits the result f_{P}(X₂, Y₁) to the statistical processing result provision server 50, and the fourth cloud service facility 30-4 calculates the inner product of the N pairs of partial data items x₂ᵢ and y₂ᵢ and transmits the result f_{P} (X₂, Y₂) to the statistical processing result provision server 50.

The statistical processing result provision server 50 determines the sum of all the transmitted results. This means that the inner product of the original data items xᵢ and yᵢ is determined, since the value of “f_{P} (X₁ᵢ, Y₁)+f_{P}(X₁, Y₂)+f_{P} (X₂, Y₁)+f_{P} (X₂, Y₂)” equals the value of the sum of (x₁ᵢ+x₂ᵢ) and (Y₁ᵢ, y₂ᵢ) multiplied by each other for i=1 to N.

Once the inner product, and the sum and the sum of squares as needed, are obtained as described above, they can be broadly applied to various statistical analysis techniques as illustrated below.

The covariance Cov_{XY} can be determined as

Cov_{XY}(f_{P}(X,Y)−f_{Σ}(X)f_{Σ}(Y))/N,

since

Cov_{XY}=1/N×Σ(xᵢ−m_{X})(yᵢ−m_{Y}),

m_{X}=f_{Σ}(X)/N, and

m_{Y}=f_{Σ}(Y)/N,

where m_{X} and m_{Y} are the sample means of X and Y, respectively.

The coefficient of correlation CC_{XY} can be determined as

CC_{XY}=Cov_{XY}/s_{X}s_{Y},

where s_{X} and s_{Y} are the sample deviations of X and Y, respectively, and s_{X}=[(f_{S}(X)−{f_{Σ}(X)}²)/N]^{1/2} and s_{Y}=[(f_{S}(Y)−{f_{Σ}(Y)}²)/N]^{1/2}

Once the means m_{X} and m_{Y}, the variances s_{X}² and s_{Y}², and the covariance Cov_{XY} are determined as described above, they can be applied to the formula for the coefficient of a primary expression in regression analysis, and also variation, residual sum of squares, and coefficient of determination can be calculated.

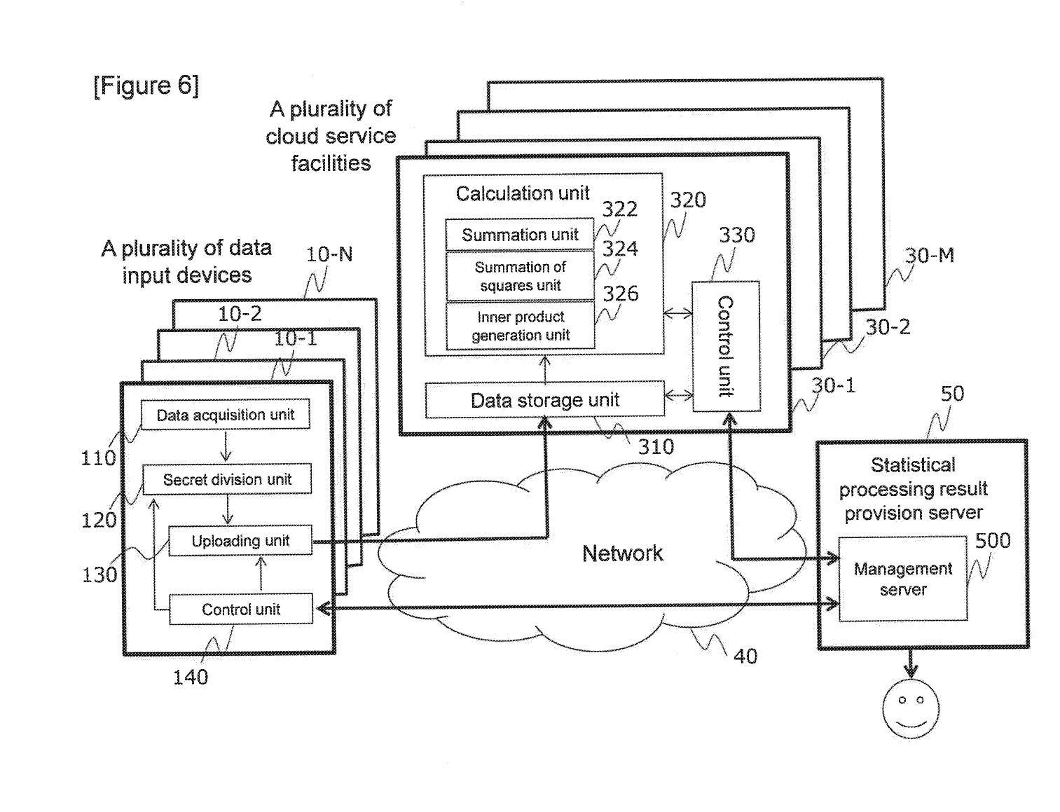

FIG. 6 shows an example of the present system's potential configurations described with reference to FIGS. 1 to 5. The data input devices 10-1 to 10-N (20-1 to 20-N, though not shown, for determining an inner product have the same configuration), the cloud service facilities 30-1 to 30-M, and the statistical processing result provision server 50 are connected with one another via a network 40 (e.g. the Internet).

There may be a configuration in which there are separate communications networks (e.g. wireless and wire networks, etc.) between each data input device 10 and each cloud service facility 30, between each cloud service facility 30 and the statistical processing result provision server 50, and between the statistical processing result provision server 50 and each data input device 10.

As for the security of communications between them, an existing sufficiently secure encryption for communications is used. Particularly, it is preferable to use an encryption technique which is as secure as those used, for example, for online shopping, electronic payment, commerce transactions, online banking, or the like for communications between each data input device 10 and each cloud service facility 30, since, even though their individual communication includes only a divided data item, original data could be restored if the entire communication from one data input device to m cloud service facilities were intercepted.

As shown in FIG. 6, each data input device 10 comprises: a data acquisition unit 110; a secret division unit 120 for dividing an acquired original data item in a secret manner; and an uploading unit 130 for uploading a partial data item obtained by secret division through an encrypted communication channel to each cloud service facility 30. The data acquisition unit 110 may be for a device to automatically generate an original data item, may be for a person to input an original data item, or may extract an original data item from another database or the like.

A control unit 140 comprised in each data input device 10 follows an instruction from a management unit (management server) 500 in the statistical processing result provision server 50 to control the number of divisions of data and the kind of partial data items to be generated in the secret division unit 120. The control unit 140 also follows an instruction from the management server 500 to control the destination to which each partial data item is uploaded by the uploading unit 130.

In this regard, if cloud service facilities to which data items are uploaded are determined in advance, the control may be done by following control information embedded in the control unit 140 without communicating with the statistical processing result provision server 50.

Each cloud service facility 30 comprises: a data storage unit 310 for storing data uploaded from each data input device 10; and a calculation unit 320 for performing summation (322), summation of squares (324), inner product calculation (326), or other arithmetic processes on multiple stored partial data items. Any of these arithmetic processes can be calculated in an amount of calculation O(N) for the number of data input devices N, and the system can be scaled (extended) at a practical level even when N is as large as on the order of hundreds of millions or trillions.

The calculation unit 320 need only provide for necessary arithmetic processes depending on the intended use of the present system. For example, if it is determined in advance that the present system is not used for determining inner products, the calculation unit 320 need not comprise the inner product generation unit. Alternatively, the calculation unit 320 may be configured to be able to have various arithmetic units for the expansion of use so that arithmetic units to be used are chosen for each statistical process in accordance with an instruction from the management server 500.

A control unit 330 comprised in each cloud service facility 30 follows an instruction from the management unit (management server) 500 in the statistical processing result provision server 50 to determine the time for the calculation unit 320 to perform a predetermined arithmetic process, and data items to be read from the data storage unit 310 for the arithmetic process.

Each data input device 10 is configured, for example, by installing a program for the present scheme on a device having a computing capability. The device may be a general purpose computer or a dedicated device manufactured with the program being integrated. A section that temporarily retains original data before secret division, a section where the secret ratio for secret division is used, or the like may particularly be provided in a highly secure hardware or software module.

If each data input device 10 is a dedicated device with a small storage capacity or the like, the address (URL, IP address, or the like) of the manager that administers statistical processing (the management server 500) and a key for encrypting communications with the manager (the public key system or the common key system) may be set as initial information and the address of each cloud 30 or the like may be acquired by using the manager in order to minimize the initial information embedded in the device.

Each cloud service facility 30 can be realized by using a commonly provided cloud service facility.

The statistical processing result provision server 50 can be configured, for example, by installing a program for the present scheme on a general purpose server, and the statistical processing result provision service itself may be realized as a calculation service in a cloud.

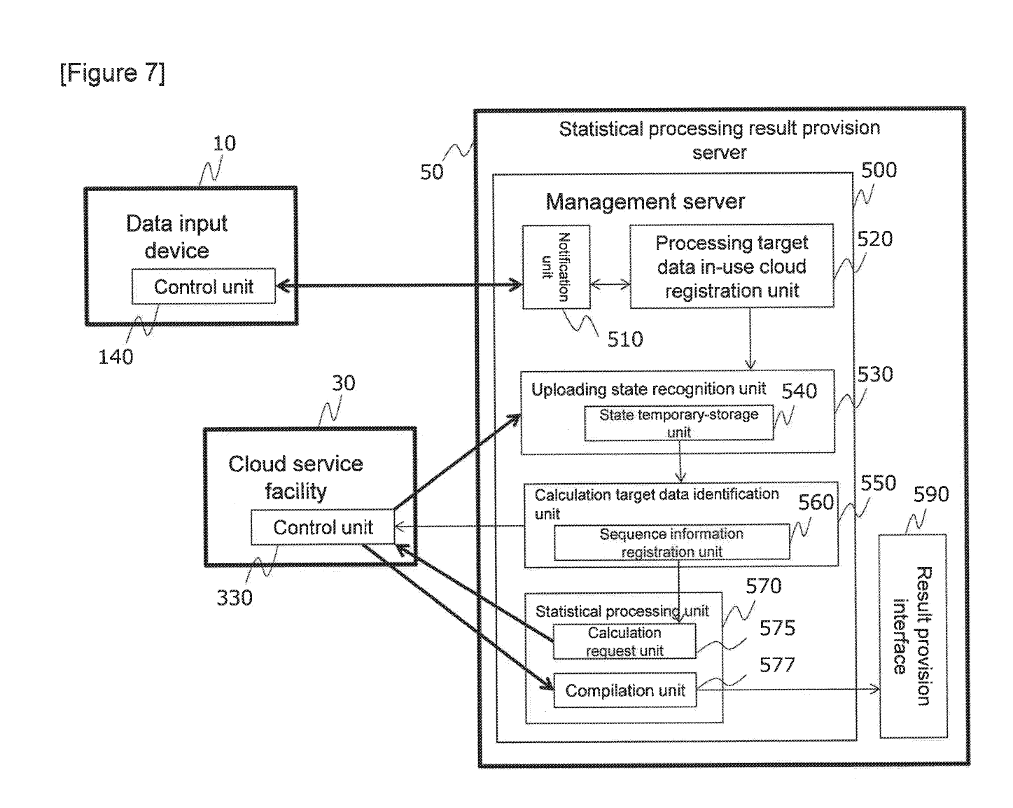

FIG. 7 shows an example of the internal configuration of the statistical processing result provision server 50. The statistical processing result provision server 50 comprises: the management unit (management server) 500 having a function to control each data input device 10 and each cloud service facility 30 as well as a statistical processing unit 570; and a result provision interface 590 for providing a user with the statistical processing result.

When the statistical processing result provision server 50 is to be allowed to perform a plurality of independent statistical processes for the purpose of providing a plurality of independent users with the results, each of the statistical processes is provided with a function of the management server 500, which is called a manager. Managers can be distinguished, for example, by assigning a different URL to each manager.

The function of each unit in FIG. 6 and FIG. 7 described below can be implemented by hardware or software, or by a combination of hardware and software. When there coexist a plurality of statistical processes, a manager 50-1 that administers a target statistical process 1 functions as the management server 500.

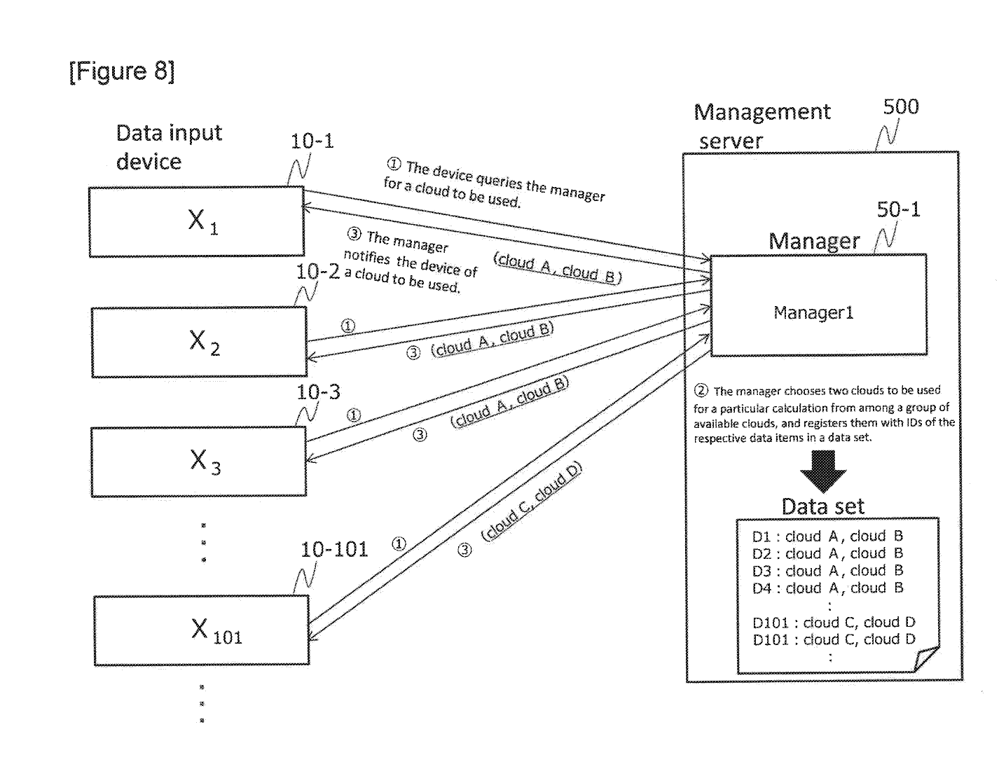

FIGS. 8 through 15 are intended to illustrate an example of procedures in the present system. The management server 500 that realizes the procedure of the present example comprises, for example, the units shown in FIG. 7.

Before starting the procedure of the present example, the statistical processing result provision service provider estimates the number of clouds to be used for the relevant statistical process and calculation resources (the number of units, CPU, memory, etc.) required by each cloud, and designs the present system. The provider then chooses a required number of independent cloud service providers, and contracts with them for the cloud resources. After that, the provider executes the procedure below and, when it has obtained a necessary statistical processing result, initializes (completely deletes) the data in order to certainly eliminate the risk of information leakage and terminates the contract for the cloud resources.

FIG. 8 shows a preparative procedure performed between a notification unit 510 of the manager and each data input device 10. Each data input device queries a predetermined manager [1], and the manager chooses two clouds in the case of the example in FIG. 1 from a group of M available clouds [2] and notifies each data input device of the information [3]. The manager also notifies each data input device of information indicating which cloud what kind of data is to be uploaded to in the cases of the examples in FIGS. 3 to 5 [3]. The manager stores the details notified of to the data input device in a processing target data in-use cloud registration unit 520 as being related to the ID of each original data item (this may be the ID of the data input device if there is one data item for each device) [2].

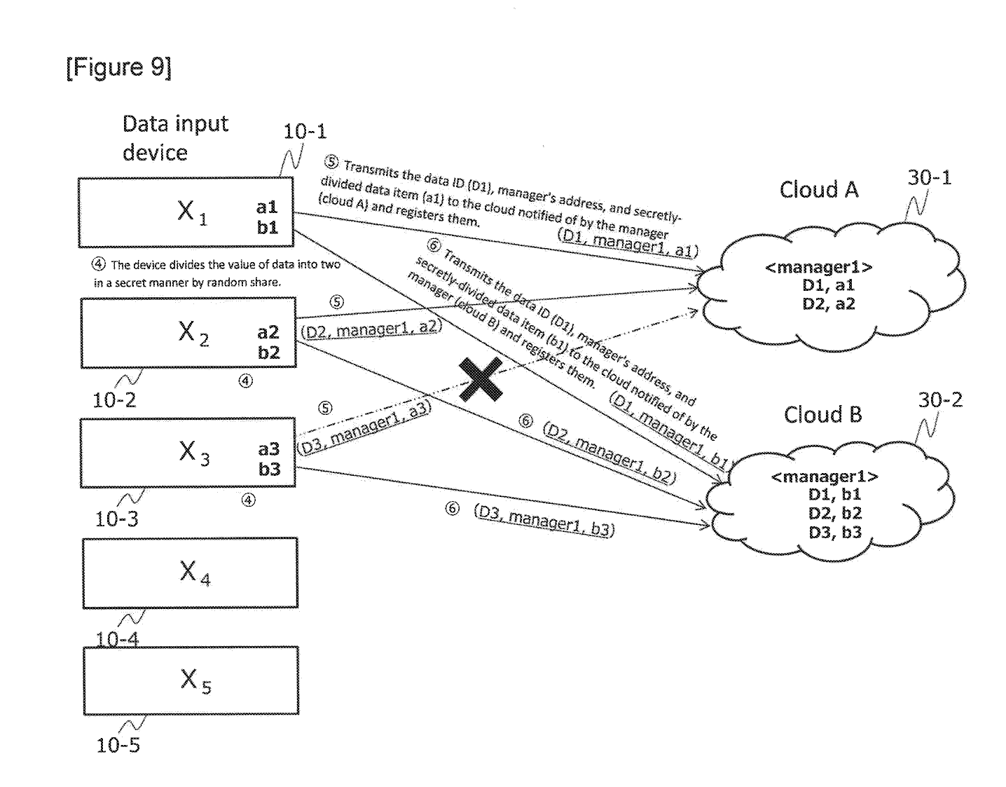

FIG. 9 shows a procedure for each data input device 10 to upload each partial data item obtained by secret division [4] to each cloud service facility [5] [6] in accordance with the details notified of by the manager. In addition to the partial data item, each data input device 10 also uploads the managers address or other identification information and the ID of the data. In this regard, [5] and [6] may be done at the same time or at different times, and the times when each data input device 10 executes [4] to [6] may be independent of one another. In other words, it is not required to synchronize data input devices, and [4] to [6] are executed when each data input device 10 acquires original data.

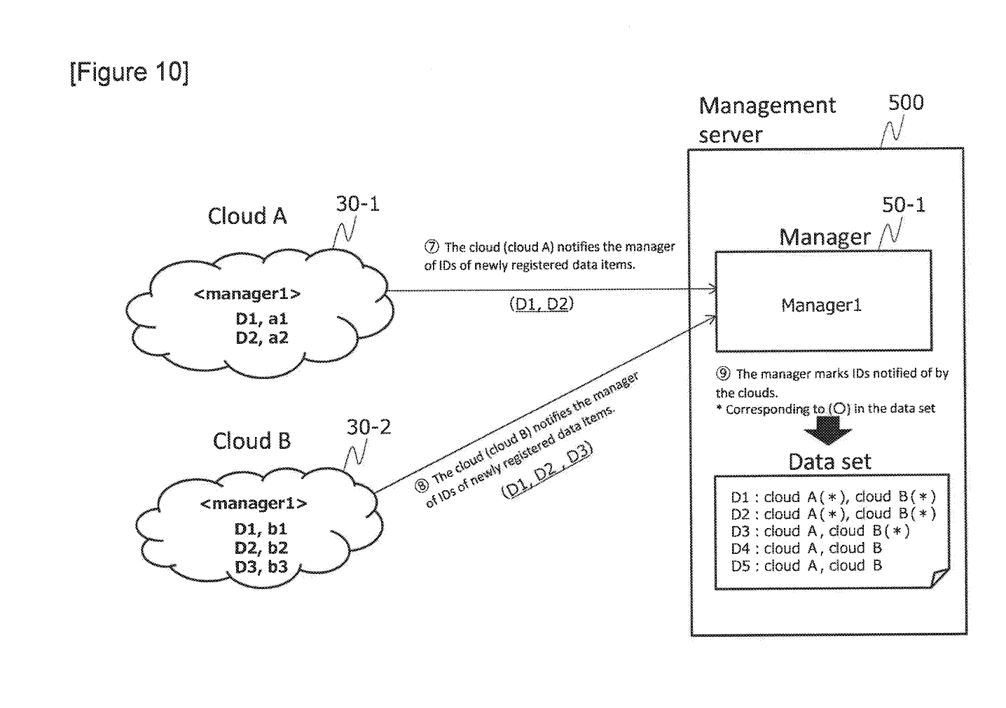

FIG. 10 shows a procedure for each cloud service facility 30 to notify the manager's uploading state recognition unit 530 of the ID of uploaded data at its own timing [8] [9]. Upon receiving these notifications, the manager marks, as uploaded, a notified cloud out of a plurality of clouds registered in the processing target data in-use cloud registration unit 520 corresponding to each data ID, or does a thing like that, to store in a state temporary-storage unit 530 the state of the data ID which is in a state where it is notified of by part of the plurality of registered clouds [9]. This allows the manager to manage which cloud a partial data item of which data is stored in without receiving partial data items themselves.

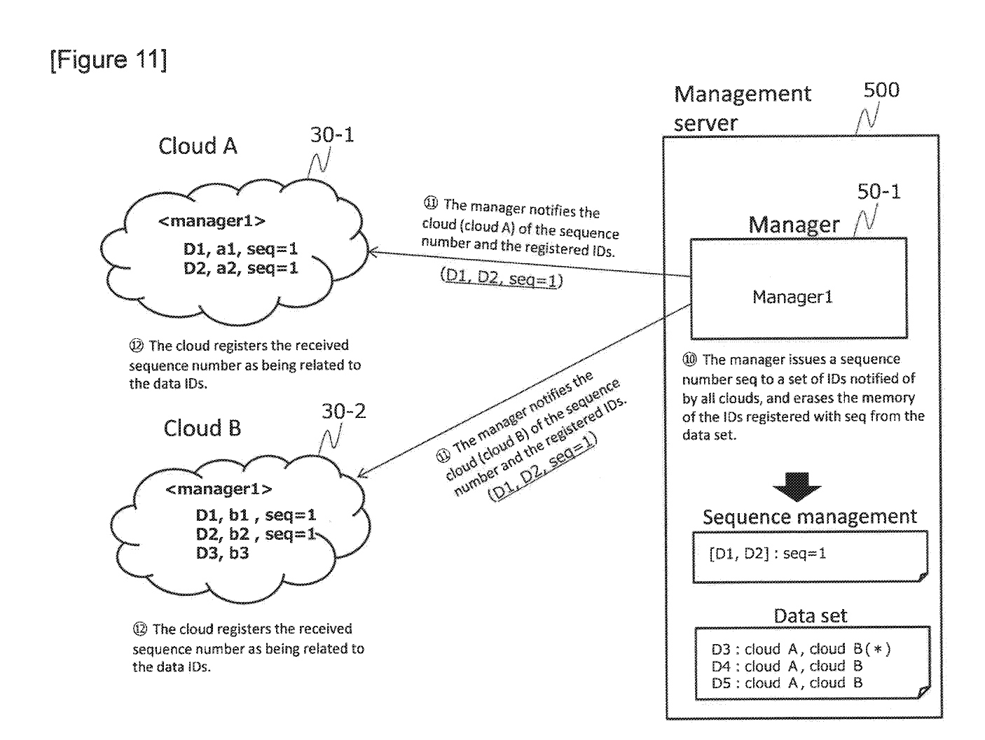

FIG. 11 shows a procedure for a calculation target data identification unit 550 of the manager to share with each cloud service facility 30 data IDs whose partial data items are received by all the clouds. When a state is reached in which a data ID stored in the state temporary-storage unit 540 is notified of by all the registered clouds, the manager issues a sequence number corresponding to such a data ID or group of data IDs, and registers the issued sequence number and the ID or group of IDs in a sequence information registration unit 560 [10]. The manager then erases the memory of the registered ID or group of IDs from the state temporary-storage unit 530 [10].

After that at a predetermined timing, the calculation target data identification unit 550 of the manager notifies each cloud service facility 30 of the sequence number and the corresponding ID or group of IDs [11]. This notification may be made each time a sequence number is issued, or information on several sequence numbers may be collectively notified of. Each cloud service facility 30 stores the correspondences between the IDs of the uploaded partial data item stored by itself and the sequence numbers notified of [12].

In a case, for example, where a partial data item with ID=3 has reached the cloud B but has not reached the cloud A as shown in FIG. 9, the management shown in FIG. 10 lets only ID=1 and 2 whose partial data items have reached all the clouds A and B be notified of as being corresponding to the sequence number=1 in FIG. 11.

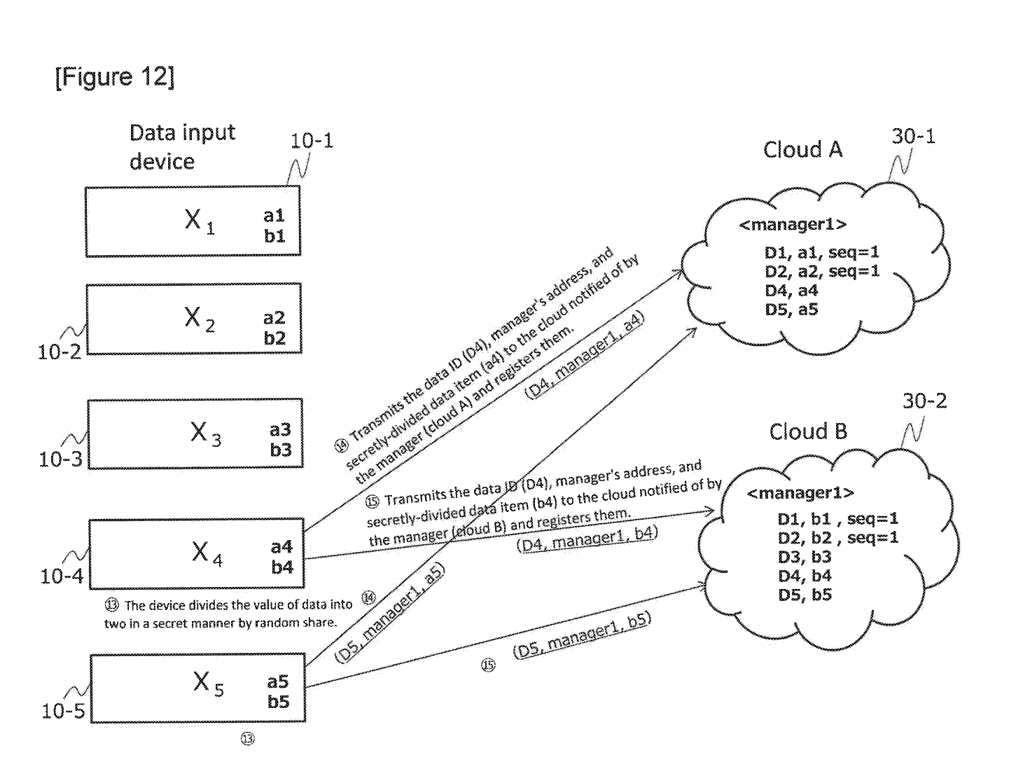

FIG. 12 is a follow-up to FIG. 9, where each partial data item with ID=4 and each partial data item with ID=5 are generated by secret division in each data input device 10 [13] and are uploaded to each cloud service facility [14] [15].

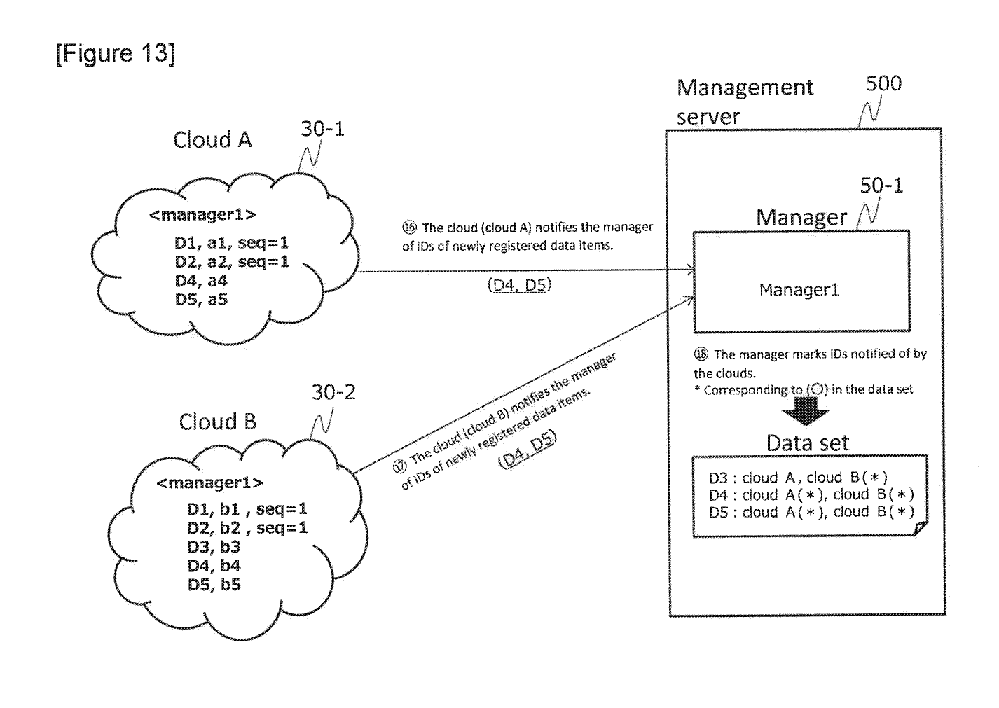

FIG. 13 shows how each cloud upon receiving the uploading in FIG. 12 notifies the manager [16] [17] and the manager stores the state [18] as described in FIG. 10.

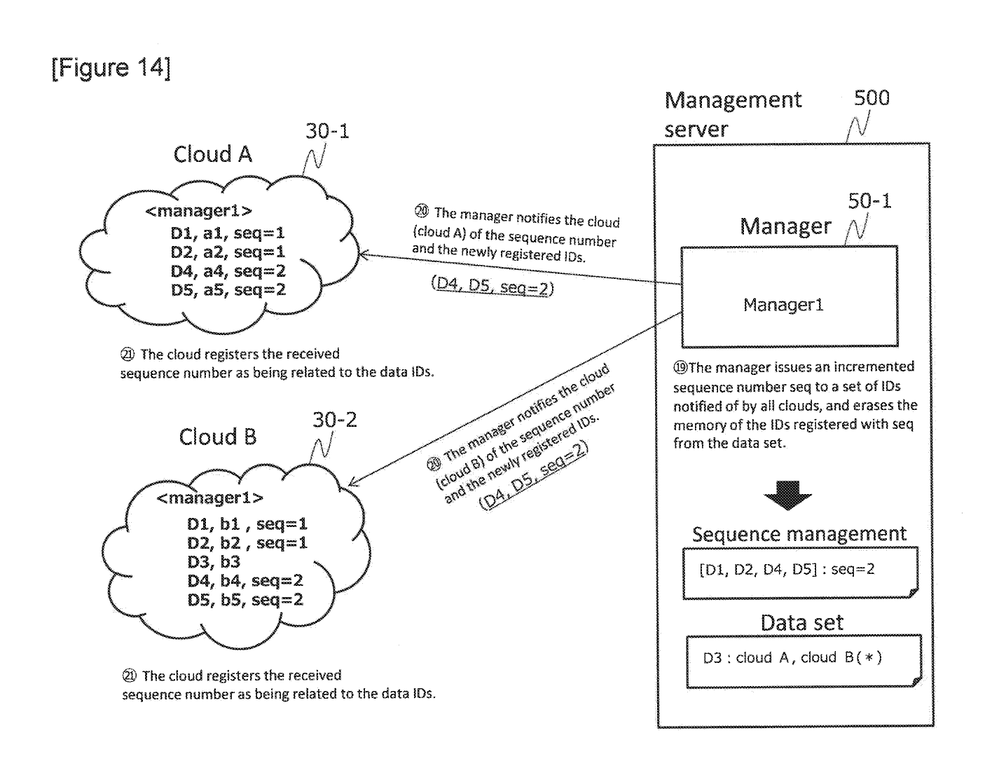

FIG. 14 shows how the manager, upon receiving the notification in FIG. 13 and after issuing the sequence number described in FIG. 11, issues a new sequence number corresponding to a data ID or group of data IDs which have been notified of by all the registered clouds [19], notifies each cloud [20], and has it store the correspondence [21].

For example, if partial data items with ID=4 and 5 has reached all the clouds A and B while a partial data item with ID=3 has not reached the cloud B, the manager registers ID=4 and 5 as being corresponding to a new sequence number=2.

In this regard, if it is not required to perform statistical processing on past data for some use, the manager may add ID=1 and 2, which are registered corresponding to the sequence number=1, as being corresponding to the sequence number=2, and may delete the registration for the sequence number=1. Each cloud may store ID=1 and 2 as being corresponding to the sequence number=1 and ID=4 and 5 as being corresponding to the sequence number=2 as notified by the manager and, later when the sequence number=2 is designated, may interpret the designation as designating data items with groups of Ds corresponding to the designated sequence number and to sequence numbers which are smaller than the number; or alternatively may rewrite and store the sequence numbers so as to indicate the interpretation.

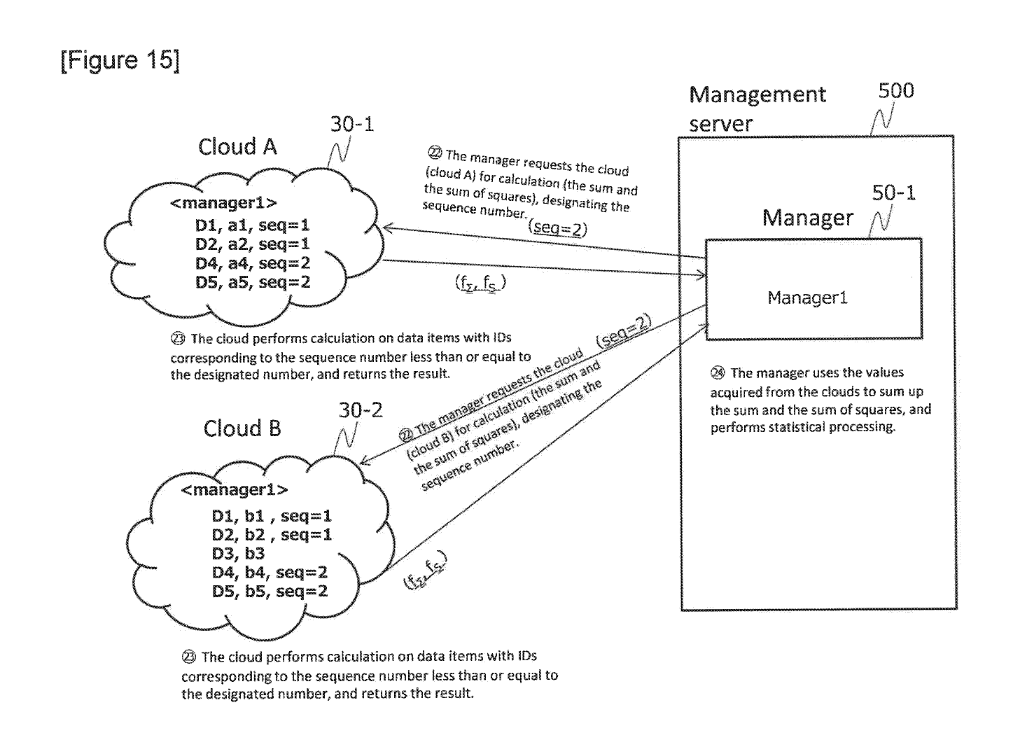

FIG. 15 shows a procedure of a step in which the manager obtains a statistical processing result. A calculation request unit 575 of the managers statistical processing unit 570 requests all clouds that store partial data items to perform calculation processes with the present sequence number (the sequence number at the time of designation if statistical processing is performed on past data) as an argument [22]. In this regard, information to be passed from the manager to each cloud can be only a sequence number. In the example in FIG. 3 or 4, the processes to be performed in each cloud are calculation of the sum and the sum of squares.

Each cloud service facility 30 already stores which group of IDs corresponds to the designated sequence number and therefore, upon receiving the request, performs calculation processes on partial data items with the group of IDs and returns the value of the result to the manager [23].

When the results are returned from all the requested clouds, a compilation unit 577 of the manager's statistical processing unit 570 sums up their values or does a thing like that to calculate a statistical value to be obtained [24]. If the manager performs different processes depending on which cloud the result is from, such as doubling the value from some clouds as in FIG. 3, the compilation unit 577 refers to information indicating the correspondence between clouds stored in the processing target data in-use cloud registration unit 520 and the kind of data to be uploaded.

As described above, the use of sequence numbers managed by the manager allows statistical processing results to be determined for data whose partial data items are gathered in all clouds (ID=1, 2, 4, and 5 in the above example), thus insuring data integrity.

The use of sequence numbers for the manager to frequently share information on data IDs that may be targeted for calculation processes with each cloud allows for a distribution of the communication load and a faster response to the request for calculation for statistical processing.

In other words, though the present system can also be realized by a configuration in which the manager, without sharing information on data IDs (without having the calculation target data identification unit 550), notifies of all data IDs to be targeted (whose partial data items are gathered in all clouds) (notifies of information of ID=1, 2, 4, and 5 instead of the sequence number=2 in the above example) when requesting each cloud for calculation processes, it is preferable to share information using sequence numbers when statistical processing for a huge number of data items is performed.

APIs (interfaces) between the manager and other devices in the present system are configured not to pass original data and even individual partial data items forming original data at all. APIs between each data input device that handles original data and other devices are configured in such a way that access is made only by each data input device ([1] in FIG. 8, [5] and [6] in FIG. 9, etc.) and is not made from the outside to each data input device. APIs between each cloud that holds partial data items while original data is not existing but hidden and other devices are configured to prevent extraction of partial data items from each cloud. These APIs, too, maintain the security of data to be hidden.

In addition to the APIs described above, the manager's statistical processing unit 570 enhances security if it is configured to, after processing a group of data items corresponding to a sequence number, avoid sending the next calculation request to each cloud until data IDs of a certain amount (an amount large enough to virtually preclude making a guess as to individual data items, like ten thousands) or more are added to be processed. This is because, for example, if the manager determines the sum for the sequence number=2 (ID=1, 2, 4, and 5) and then determines the sum for the sequence number=3 (ID=1, 2, 4, 5, and 7), the added individual element, the original data with ID=7, is determined by subtraction.

Since in the configuration example of the present system described in FIGS. 6 to 15 the statistical processing result provision server (the manager) manages information on which cloud service facility each partial data item generated by each data input device is stored in, a malicious attacker cracking the server could get a clue to each data item's owner, storage location, or the like.

In order to reduce even such a possibility, each data input device itself can preferably determine which cloud service facility each partial data item is to be stored in (an upload destination) without communicating with the statistical processing result provision server, so that the statistical processing result provision server does not handle information identifying each data input device.

For a concrete example, each data input device can use a consistent hashing scheme (see: D. Karger et al. “Consistent Hashing and Random Trees: Distributed Caching Protocols for Relieving Hot Spots on the World Wide Web,” Proceedings of the 29th Annual ACM Symposium of Theory of Computing, pp. 654-663 (1997); I. Stoica et al. “Chord: A scalable peer-to-peer lookup service for Internet applications,” ACM SIGCOMM Computer Communication Review 31(4), p. 149 (2001); or the like for example) to determine a cloud service facility in which data is to be stored.

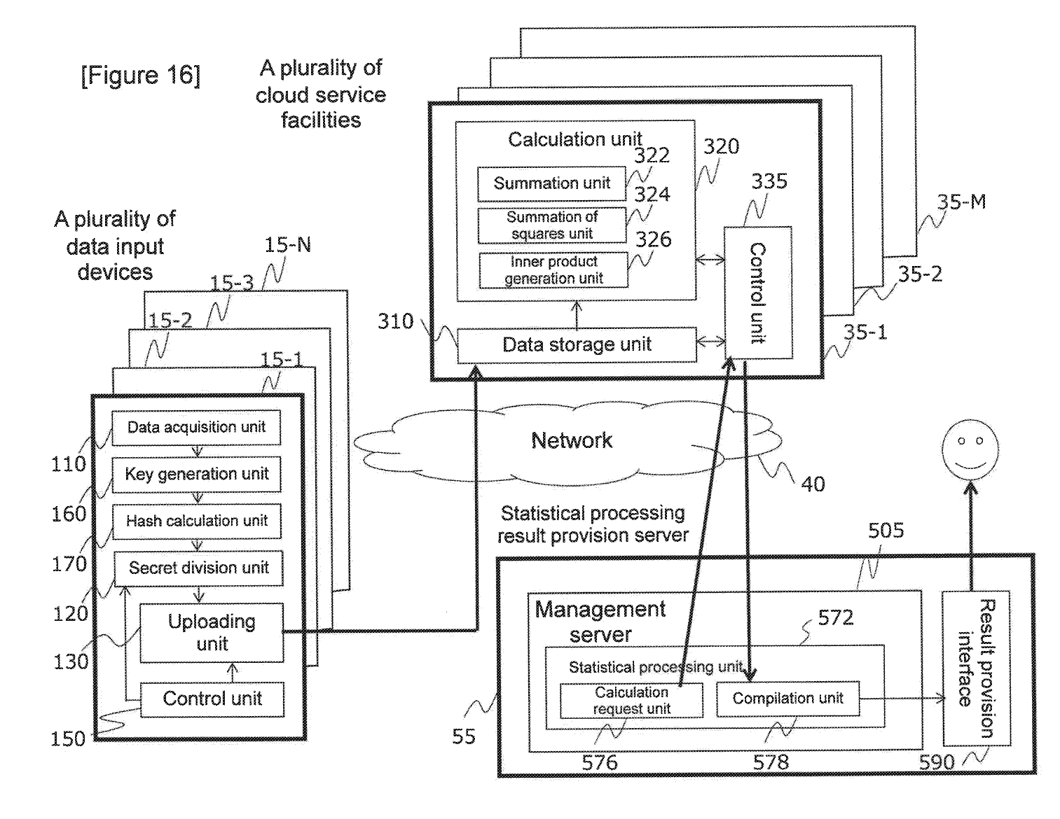

FIG. 16 is an example of the present system configured as such. Blocks designated by the same letters as in the example in FIGS. 6 and 7 have the same functions as described with reference to FIGS. 6 and 7.

Though data input devices 15-1 to 15-N, cloud service facilities 35-1 to 35-M, and a statistical processing result provision server 55 are connected together via a network 40 in FIG. 16, each data input device 15 and the statistical processing result provision server 55 do not communicate with each other.

Each data input device 15 comprises: a data acquisition unit 110; a secret division unit 120; an uploading unit 130 for uploading a partial data item obtained by secret division through an encrypted communication channel to each cloud service facility 35; and additionally a key generation unit 160 and hash calculation unit 170 for determining an upload destination by consistent hashing.

A control unit 150 comprised in each data input device 15 controls the number of divisions of data and the kind of partial data items to be generated in the secret division unit 120, and additionally causes the key generation unit 160 to generate a key unique for each secretly-divided data item (e.g. a UUID (universally unique identifier, an IPv6 (Internet Protocol version 6) address, etc.) and causes the hash calculation unit 170 to sum up the generated key, the time, and the sequence number and calculate a hash value from the value of the sum.

For example, if a group of values (a range) with a predetermined span is assigned to each cloud service facility 35 in advance, a cloud service facility whose range includes the calculated hash value can be identified as the destination to which the data is uploaded. This scheme allows the control unit 150 to designate the upload destination of each partial data item for the uploading unit 130 in accordance with the hash value calculated for each partial data item, and thus eliminates the need for each data input device to query the statistical processing result provision server (the manager) for a cloud to which the data is to be uploaded.

A control unit 335 comprised in each cloud service facility 35 follows an instruction from a management unit (management server) 505 in the statistical processing result provision server 55 to determine the time for a calculation unit 320 to perform a predetermined arithmetic process. Data items to be read from a data storage unit 310 for the arithmetic process are determined by the control unit 335 itself.

The statistical processing result provision server 55 comprises the management server 505 and a result provision interface 590. The management server 505 comprises a statistical processing unit 572, requests each cloud service facility 35 for calculation processes (calculation request unit 576), compiles calculation results returned in response to each request (compilation unit 578), and obtains the statistical processing result.

Unlike the statistical processing result provision server 50 (the management server 500) in FIG. 7, the statistical processing result provision server 55 (the management server 505) in FIG. 16 does not have a function to notify each data input device of an upload destination cloud or a function to recognize the state of uploading or to identify data to be used for calculation. Accordingly, the statistical processing result provision server 55 (the manager) does not have any clue to individual data items at all.

The manager recognizes which cloud can be used (which cloud is recognized by each data input device as being assigned with the above-described range) for its own statistical processing, and requests all clouds, which can be used, to calculate the sum and the sum of squares when performing statistical processing. However, the manager cannot recognize which data input device the data on which the calculation in each cloud is performed is from, so that data security can be ensured also against the manager.

The use of consistent hashing offers the further advantage of being able to ensure scalability even if the number of clouds increases and to realize a system quite capable of distributed processing.

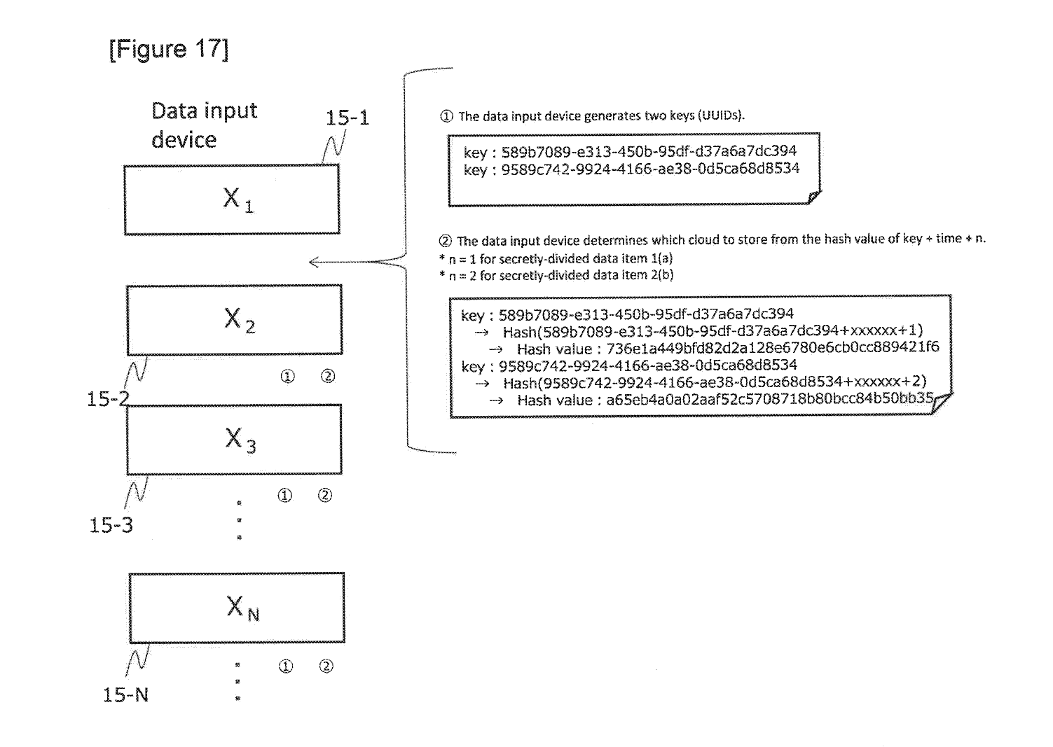

FIGS. 17 to 19 show an example of a procedure, in the configuration example in FIG. 16, for each data input device Xᵢ to divide acquired data Aᵢ into two partial data items aᵢ and bᵢ in a secret manner and upload them to two clouds arbitrarily chosen from a plurality of clouds (four in the present example, but may be many) for statistical processing.

FIG. 17 shows a preparative procedure performed in each data input device 15. Each data input device uses UUIDs to generate two keys (k₁ and k₂) [1] in order to determine clouds to which the two partial data items are uploaded. Each data input device then adds the time (time) and the sequence number n (1 and 2) to the respective keys (k₁ and k₂) to calculate hash values (h₁ and h₂) from the values of their respective sums.

In this regard, each cloud is assigned with values 0000 to ffff, and a ring is formed. For example, when there are four clouds, a group of values from 0000 to 3fff can be assigned to Cloud A, a group of values from 4000 to 7fff can be assigned to Cloud B, a group of values from 8000 to bfff can be assigned to Cloud C, and a group of values from c000 to ffff can be assigned to Cloud D. While in the present example the assigned range is equally divided, the range of a group of values assigned to one cloud may be wider than the range of a group of values assigned to another cloud. Clouds whose assigned groups of values include the calculated hash values (h₁ and h₂) are respectively determined to be destinations to which the corresponding partial data items (aᵢ and bᵢ) are uploaded [2].

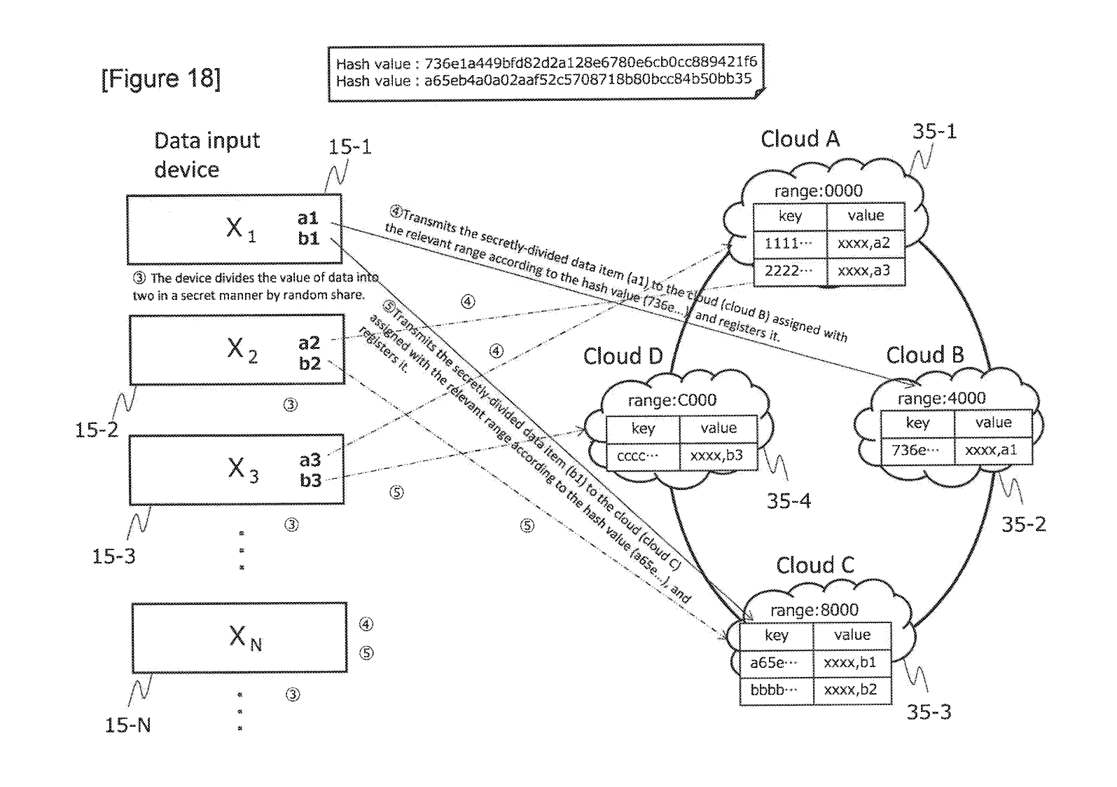

FIG. 18 shows a procedure for each data input device 15 to upload each partial data item (aᵢ and bᵢ) obtained by secret division [3] to each cloud service facility 35 [4] [5]. Each data input device 15 may upload only the partial data items, or may also upload the manager's address or the like (identification information for statistical processing) in addition to the partial data items.

While [4] and [5] may be done at the same time or at different times, an erroneous result is produced if statistical processing, during a time lag before partial data items obtained from one data item by secret division are completely stored in the clouds, is performed on the data. In order to prevent this, if each cloud has a function to limit calculation targets to data items marked with a time a predetermined time or more before the current time or does a thing like that, the time may be uploaded in addition to the partial data items. In the configuration example in FIG. 16, however, data Ds are not uploaded.

The process of [4] and [5] is specifically as follows. Each data input device Xᵢ transmits at its own timing a partial data item aᵢ obtained in [3] (and a time as needed) to a cloud corresponding to the hash value h₁ generated with n=1 in [2]. In the example in FIG. 18, the data input device X₁ transmits the partial data item aᵢ to the cloud B, the data input device X₂ transmits the partial data item aᵢ to the cloud A, and the data input device X₃ transmits the partial data item aᵢ to the cloud A.

If the above-described storage of the partial data item aᵢ in its upload destination is performed by using a key-value store, the partial data item aᵢ is transmitted with the corresponding hash value h₁. Each cloud then stores the hash value h₁ as a key and the partial data item aᵢ (and a time as needed) as a value in the data storage unit 310, and makes reception confirmation notification to the data input device Xᵢ [4].

Similarly, each data input device Xᵢ transmits at its own timing a partial data item bᵢ obtained in [3] (and a time as needed) to a cloud corresponding to the hash value h₂ generated with n=2 in [2]. In the example in FIG. 18, the data input device X₁ transmits the partial data item bᵢ to the cloud C, the data input device X₂ transmits the partial data item bᵢ to the cloud C, and the data input device X₃ transmits the partial data item bᵢ to the cloud D.

The partial data item bᵢ is transmitted with the corresponding hash value h₂, and each cloud stores the hash value h₂ as a key and the partial data item bᵢ (and a time as needed) as a value in the data storage unit 310. Reception confirmation notification is then returned to the data input device Xᵢ [5].

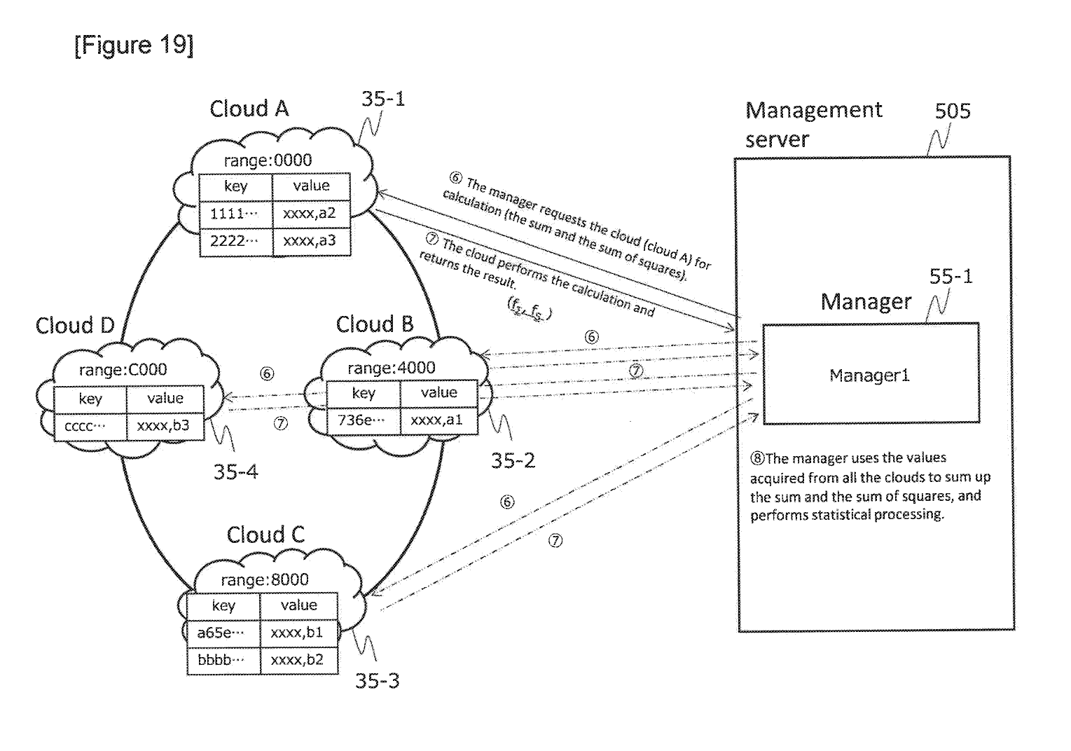

FIG. 19 shows a procedure of a step in which the statistical processing result provision server (the manager) 55 uses a plurality of clouds to obtain a statistical processing result. The manager requests all the clouds to be used for the statistical processing to perform a calculation process (e.g. calculation of the sum and the sum of squares) [6] regardless of whether target data is actually uploaded to each cloud or not (without recognizing whether a state is reached in which a part of the clouds are not chosen by any data input device, while the state can be resulted since each data input device arbitrarily chooses where to upload).

Upon receiving the request, each cloud service facility 35 performs the calculation process on partial data items stored in the data storage unit 310, and returns the value of the result to the manager [7]. In this regard and in consideration of the time lag described above, each cloud service facility 35 may perform the calculation process only on those of the data items stored in the data storage unit 310 which are marked with a time a predetermined time or more before the current time. In order to avoid processing partial data items once subjected to statistical processing again, partial data items subjected to the calculation process may be deleted from the data storage unit 310, or the calculation process may be performed only on unprocessed partial data items.

The manager, upon receiving the results returned from all the clouds it requested (a value of zero is returned from a cloud to which target data has not been actually uploaded), sums up their values or does a thing like that to calculate a statistical value to be obtained [8].

The configuration described above allows for determining at least the sum in the example in FIGS. 1 and 2. In order to determine the sum of squares in the example in FIGS. 3 and 4, at least two rings of clouds illustrated in FIG. 17 are set up in advance, each of m partial data items xⱼᵢ is uploaded to a cloud determined for each partial data item from among a plurality of clouds belonging to the first ring, and each of m partial data items x′ⱼᵢ is uploaded to a cloud determined for each partial data item from among a plurality of clouds belonging to the second ring.

Recognizing which of the first and second rings each cloud belongs to, the manager 55 chooses f_{S}(Xᵢ), i.e. the sum, from results from clouds belonging to the first ring, chooses f_{X}(X′ᵢ), i.e. the sum of squares, from results from clouds belonging to the second ring, and sums them up. Accordingly, the sum of squares of original data items xᵢ can be determined. The sum of original data items xᵢ can be determined by choosing f_{S}(Xᵢ) from results from clouds belonging to the first ring and summing them up.

A scheme called a marker may be introduced to the configuration example described in FIGS. 16 to 19 for a state in which some of a plurality of partial data items obtained by dividing one data item in a secret manner are stored in clouds but the rest are not and in order to be able to surely eliminate data items in such a state to obtain a statistical processing result.

Specifically, each data input device calculates a hash value for a marker in addition to a hash value for each partial data item obtained by secret division and, after confirming that partial data items forming one data item are completely stored in clouds, sets up the marker in the clouds. Information indicating the marker is stored with the partial data items when each data input device stores each partial data item in a cloud.

As a result, when a cloud is requested for a calculation process by the statistical processing result provision server, the cloud can include data in the calculation targets only if the marker associated with stored partial data items is set up, that is, if partial data items forming the data are severally and completely stored in any of the clouds, and this allows for surely preventing calculation from being made on data whose uploading from a data input device to clouds is not yet complete.

The scheme described above can also be realized by using the three-phase commitment technique (see, for example, Dale Skeen, “A Formal Model of Crash Recovery in a Distributed System,” IEEE Transactions on Software Engineering 9(3), pp. 219-228 (May 1983), etc.). While the marker described above corresponds to a coordinator in the three-phase commitment and each data input device corresponds to a cohort in the three-phase commitment, each data input device uses UUIDs etc. for unique keys and therefore will hide itself because of the address changing each time.

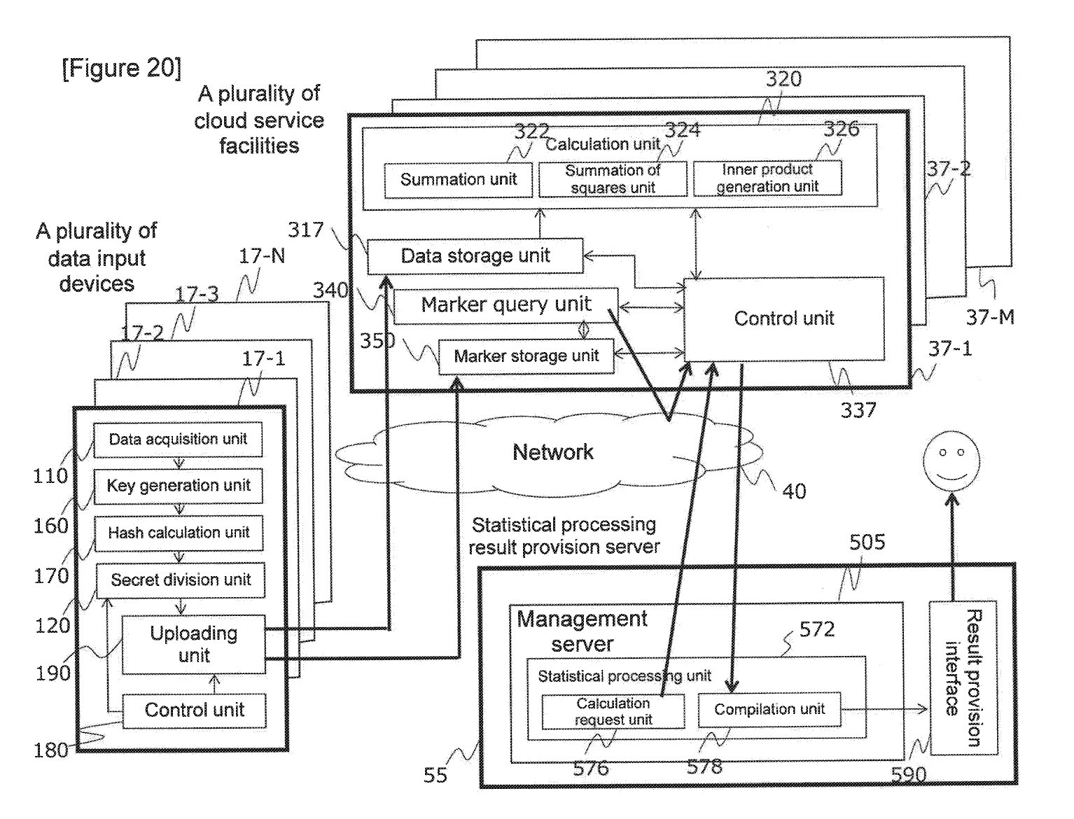

FIG. 20 is an example of the present system configured as such. Blocks designated by the same letters as in the example in FIG. 16 have the same functions as described with reference to FIG. 16.

Though data input devices 17-1 to 17-N, cloud service facilities 37-1 to 37-M, and a statistical processing result provision server 55 are connected together via a network 40 in FIG. 20, each data input device 17 and the statistical processing result provision server 55 do not communicate with each other.

Each data input device 17 comprises: a data acquisition unit 110; a secret division unit 120; a key generation unit 160; a hash calculation unit 170; and an uploading unit 190, and the uploading unit 190 has a function to upload a partial data item obtained by secret division to each cloud service facility 37 and additionally a function to upload information for setting up a marker (hereinafter referred to as “marker information”) to one of the cloud service facilities 37.

A control unit 180 comprised in each data input device 17 has functions the control unit 150 in FIG. 16 has, and additionally has a function to cause the key generation unit 160 to generate a unique key (a UUID, etc.) and cause the hash calculation unit 170 to calculate a hash value from the value of the sum of the generated key, the time, and the sequence number, for the marker. The control unit 180 also uploads marker information in conjunction with the uploading unit 190 after confirming that partial data items obtained by secret division are completely stored in clouds.

A data storage unit 317 comprised in each cloud service facility 37 has a function to store, with each uploaded partial data item, information indicating where to store the marker information and, in addition to the data storage unit 317, each cloud service facility 37 comprises: a marker storage unit 350 for storing the uploaded marker information; and a marker query unit 340 for querying the storage status of the marker information in the marker storage unit 350 of its own or others' cloud service facilities 37.

A control unit 337 comprised in each cloud service facility 37 follows an instruction from a management unit (management server) 505 in the statistical processing result provision server 55 to determine the time for a calculation unit 320 to perform a predetermined arithmetic process. The control unit 337, in conjunction with the marker query unit 340, identifies which of the partial data items stored in the data storage unit 317 the arithmetic process should be performed on.

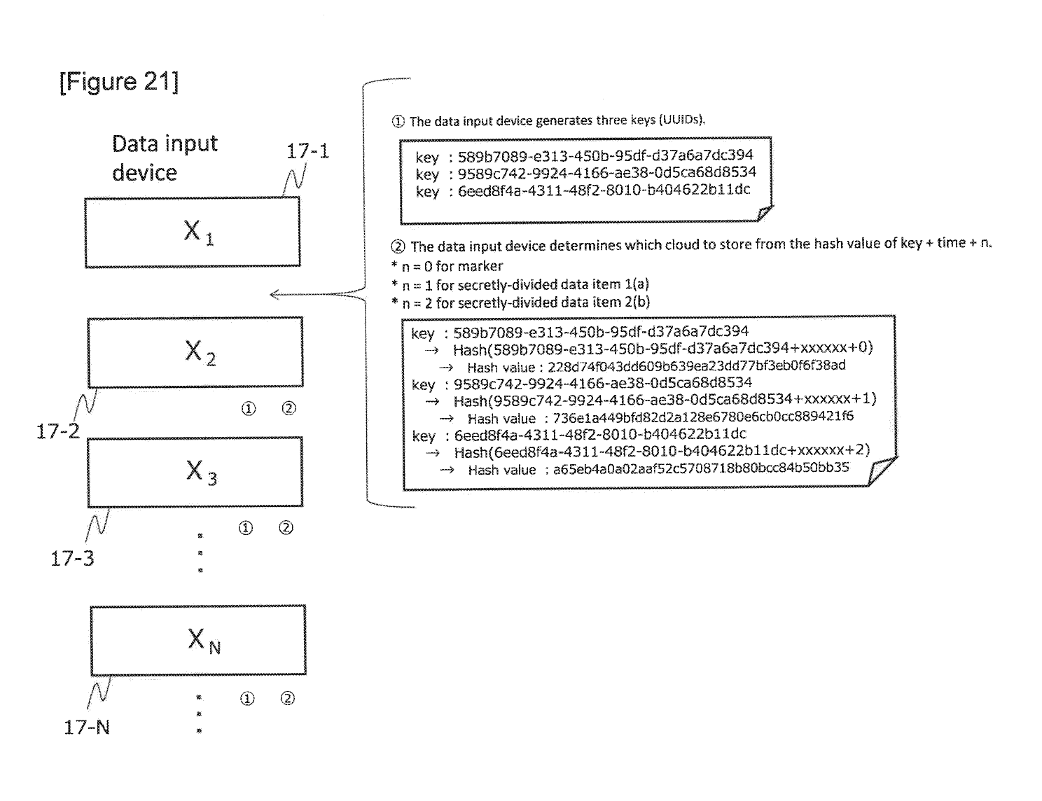

FIGS. 21 to 23 show an example of a procedure, in the configuration example in FIG. 20, for each data input device Xᵢ to divide acquired data Aᵢ into two partial data items aᵢ and bᵢ in a secret manner, upload them to two clouds arbitrarily chosen from a plurality of clouds (four in the present example, but may be many), and perform statistical processing using a marker mᵢ to insure integrity.

FIG. 21 shows a preparative procedure performed in each data input device 17. Each data input device uses UUIDs to generate three keys (k₀, k₁, and k₂) [1] in order to determine clouds to which the two partial data items and the marker information are uploaded.

Each data input device then adds the time (time) and the sequence number n (0, 1, and 2) to the respective keys (k₀, k₁, and k₂) to calculate hash values (h₀, h₁, and h₂) from the values of their respective sums. Clouds whose assigned groups of values include the calculated hash values (h₀, h₁, and h₂) are respectively determined to be destinations to which the corresponding marker and partial data items (mᵢ, aᵢ, and bᵢ) are uploaded [2].

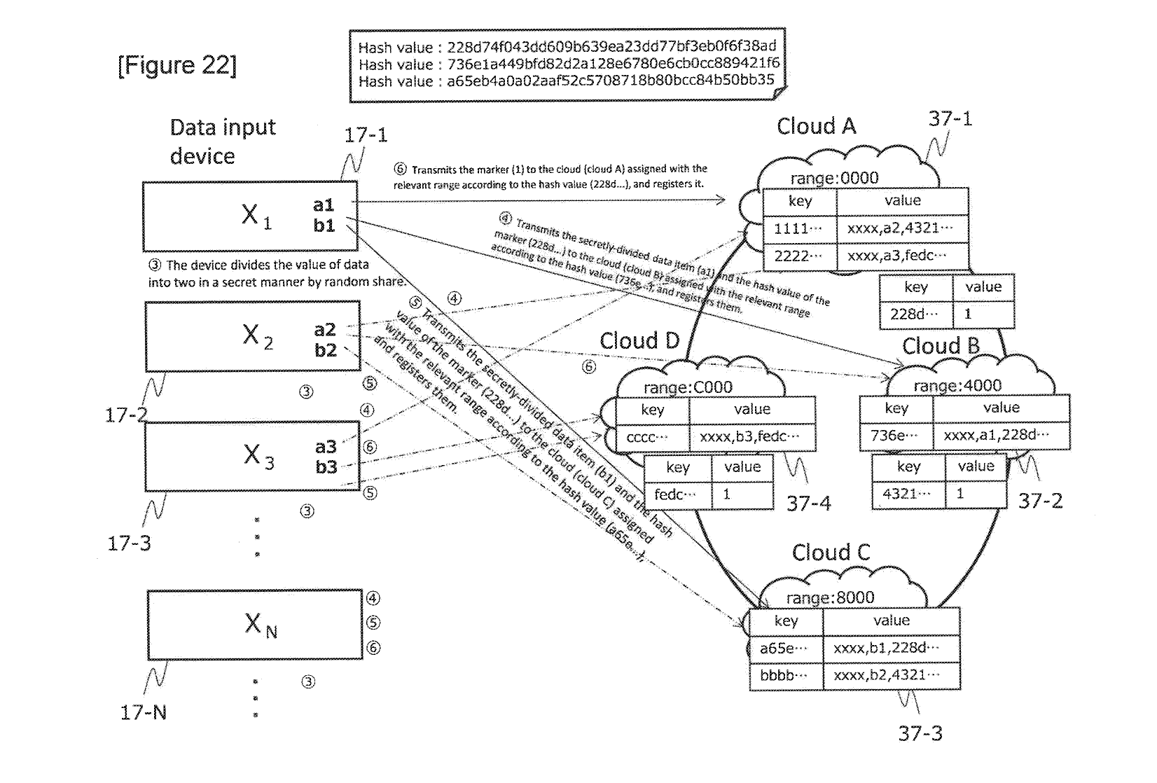

FIG. 22 shows a procedure for each data input device 17 to upload each partial data item (aᵢ and bᵢ) obtained by secret division [3] to each cloud service facility 37 [4] [5] and, after obtaining their reception confirmation, upload a marker (mᵢ) corresponding to those partial data items to a cloud service facility 37 [6].

Each data input device 17 uploads, with each partial data item, information indicating where to store the marker information (the hash value h₀ corresponding to mᵢ). In addition to these and as with the configuration example in FIG. 16, it may also upload the manager's address or the like (identification information for statistical processing). Data IDs are not uploaded also in the configuration example in FIG. 20.

In addition to the partial data items, the time may be uploaded if each cloud has a function to detect that an upper limit of time for a transaction has been exceeded (a timeout) in order to, when an upload transaction comes up with an error as to part of a plurality of partial data items obtained from one data item by secret division, cancel the transaction as to the rest of the partial data items (delete stored data items or do a thing like that), or if there is a thing like that.

The process of [4] through [6] is specifically as follows. Each data input device Xᵢ transmits at its own timing a partial data item aᵢ obtained in [3] and the hash value h₀ (and a time as needed) to a cloud corresponding to the hash value h₁ generated with n=1 in [2]. In the example in FIG. 22, the data input device X₁ transmits the partial data item aᵢ and the hash value h₀ to the cloud B, the data input device X₂ transmits the partial data item aᵢ and the hash value h₀ to the cloud A, and the data input device X₃ transmits the partial data item aᵢ and the hash value h₀ to the cloud A.

If the above-described storage of the partial data item aᵢ and the hash value h₀ in their upload destination is performed by using a key-value store, the partial data item aᵢ and the hash value h₀ are transmitted with the corresponding hash value h₁. Each cloud then stores the hash value h₁ as a key and the partial data item aᵢ and the hash value h₀ (and a time as needed) as a value in the data storage unit 317, and makes reception confirmation notification to the data input device Xᵢ [4].

Similarly, each data input device Xᵢ transmits at its own timing a partial data item bᵢ obtained in [3] and the hash value h₀ (and a time as needed) to a cloud corresponding to the hash value h₂ generated with n=2 in [2]. In the example in FIG. 22, the data input device X₁ transmits the partial data item bᵢ and the hash value h₀ to the cloud C, the data input device X₂ transmits the partial data item bᵢ and the hash value h₀ to the cloud C, and the data input device X₃ transmits the partial data item bᵢ and the hash value h₀ to the cloud D.

The partial data item bᵢ and the hash value h₀ are transmitted with the corresponding hash value h₂, and each cloud stores the hash value h₂ as a key and the partial data item bᵢ and the hash value h₀ (and a time as needed) as a value in the data storage unit 317. Reception confirmation notification is then returned to the data input device Xᵢ [5].

Upon receiving the reception confirmation notification in [4] and [5] (if successful in storing the data in the clouds), each data input device Xᵢ transmits a value (e.g. 1) for setting up the marker (mᵢ) to a cloud corresponding to the hash value h₀ generated with n=0 in [2]. In the example in FIG. 22, the data input device X₁ transmits the value for setting up the marker (mᵢ) to the cloud A, the data input device X₂ transmits the value for setting up the marker (mᵢ) to the cloud B, and the data input device X₃ transmits the value for setting up the marker (mᵢ) to the cloud D.

If the above-described setup of the marker (mᵢ) in the clouds is performed by using a key-value store, the value for setting up the marker (e.g. 1) is transmitted with the corresponding hash value h₀. Each cloud then stores the hash value h₀ as a key and the value 1 as a value in the marker storage unit 350, and makes reception confirmation notification to the data input device Xᵢ [6].

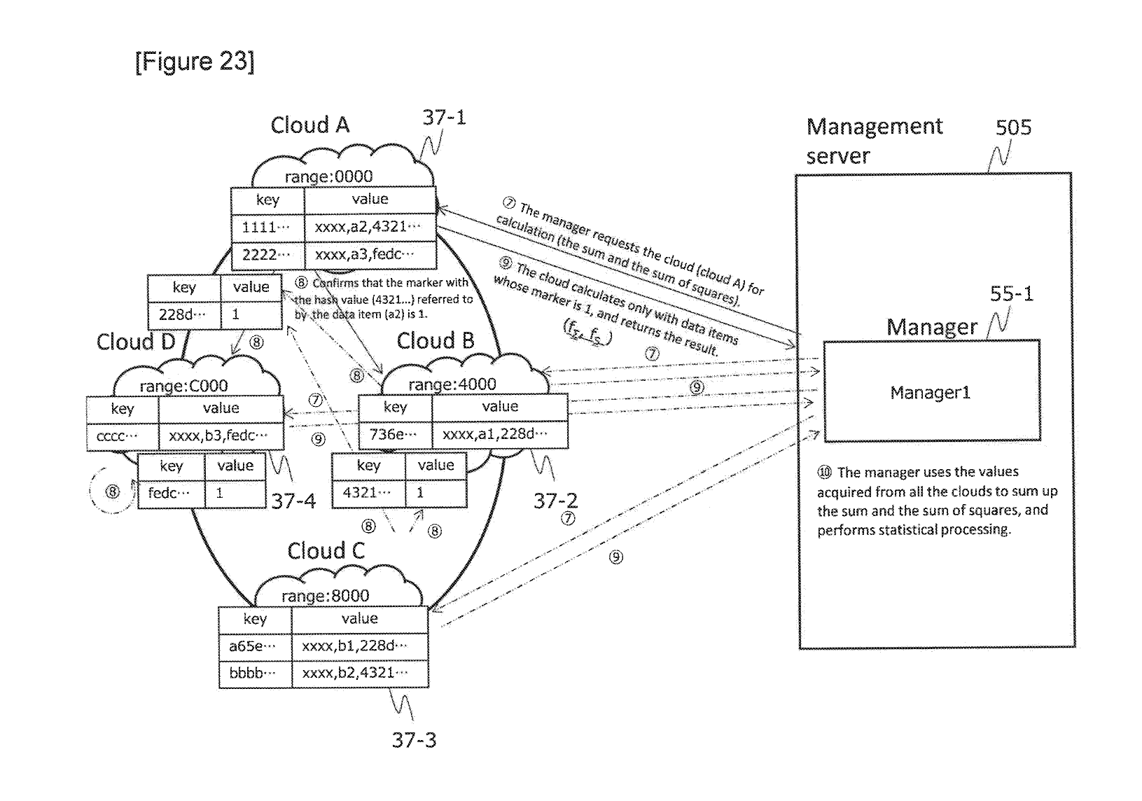

FIG. 23 shows a procedure of a step in which the statistical processing result provision server (the manager) 55 uses a plurality of clouds to obtain a statistical processing result. The manager requests all the clouds to be used for the statistical processing to perform a calculation process (e.g. calculation of the sum and the sum of squares) [7] regardless of whether target data is actually uploaded to each cloud or not.

Upon receiving the request, each cloud service facility 37 reads the hash value h₀ (information indicating where to store the marker information) stored with a partial data item in the data storage unit 317, and checks with a cloud corresponding to the hash value h₀ whether a marker is set up or not, that is, whether the value (1) for setting up a marker with the hash value h₀ used as a key is stored in the marker storage unit 350 or not [8].

In the example in FIG. 23, the cloud A makes the marker query [8] about the partial data items a₂ and a₃ stored in itself to the clouds B and D, respectively; the cloud B makes the marker query [8] about the partial data item a₁ stored in itself to the cloud A; the cloud C makes the marker query [8] about the partial data items b₁ and b₂ stored in itself to the clouds A and B, respectively; and the cloud D makes the marker query [8] about the partial data item b₃ stored in itself to itself.

If the cloud that received the query stores the queried pair of the key (the hash value h₀) and value in itself, it returns the value (1) as the value of the marker (mᵢ) to the cloud that made the query. If it does not store the pair, it returns a value indicating an error (a value other than 1) as the value of the marker.

If the value of the marker (mᵢ) returned in [8] is 1, the cloud that made the query performs the calculation process on the partial data item stored with the hash value h₀, and returns the value of the result to the manager [9]. The exclusion of partial data items whose value of the marker is not 1 from the calculation targets allows statistical processing to be accurately performed based on only such data as one data item whose partial data items forming the one data item are complete in the clouds.

The cloud that made the query may check the time stored with the hash value h₀ of the marker whose value that was returned from the cloud that received the query is not 1 and, if the time is a predetermined time (e.g. ten minutes) or more before the current time, may delete the partial data item stored therewith, regarding the transaction as not having been completed normally. If the time is within the predetermined time before the current time, the cloud may exclude the partial data item from the calculation targets and leave it intact, regarding the transaction as being possibly on the way.

The manager, upon receiving the results returned from all the clouds it requested (a value of zero is returned from a cloud to which target data has not been actually uploaded), sums up their values or does a thing like that to calculate a statistical value to be obtained [10].

The example described in FIGS. 6 to 15, the example described in FIGS. 16 to 19, and the example described in FIGS. 20 to 23 can be implemented in combination with one another as appropriate.

For example, if as a configuration for determining the inner product in the example in FIG. 5 each data input device is allowed to determine four clouds for each data item by itself (without being instructed by the manager) while each data input device uploads a partial data item and the data ID (i) to each cloud (the cloud does not notify the manager), information to be managed by the statistical processing result provision server (the manager) can be reduced. In this regard, accurate statistical processing results can also be obtained without the manager's management by registering a marker in one of the four clouds or another cloud and limiting those whose inner product is to be calculated by each cloud to partial data items whose marker is registered.

For another example and similarly to what is described in FIGS. 16 to 19, at least two rings of clouds can be set up in order to determine the sum of squares also in FIGS. 20 to 23. In such case, a cloud belonging to the first, the second, or no ring may be chosen as the cloud to which the marker is registered.

While statistical processing has been discussed so far, the present system can be configured in such a way that an owner of original data can use each cloud to which partial data items are uploaded for statistical processing to store the original data in a secret and distributed manner in advance and the owner can restore the original data whenever the owner wants to refer to it while others are not allowed to have access to it.

For this purpose, the data storage unit 310 of each cloud service facility 30 is added with a function to verify access rights with a key and, for example, information on the key is additionally uploaded when a partial data item is uploaded from the data input device 10 to each cloud service facility 30. The data storage unit 310 of each cloud service facility 30 then stores the key-based access information as well as the partial data item and, when accessed for the partial data item, permits the acquisition of the partial data item only if the person who accessed is verified to have the corresponding key.

For another example, information on a key of an owner of data may be stored in the data storage unit 310 of each cloud service facility 30 in advance and, when a partial data item is uploaded, the partial data item may be stored with the information on the corresponding key being added (e.g. by encrypting the partial data item with the key). In either case, the owner of the original data can restore the original data by accessing all clouds that store the partial data items, acquiring each partial data item using the key, and gathering all the partial data items.

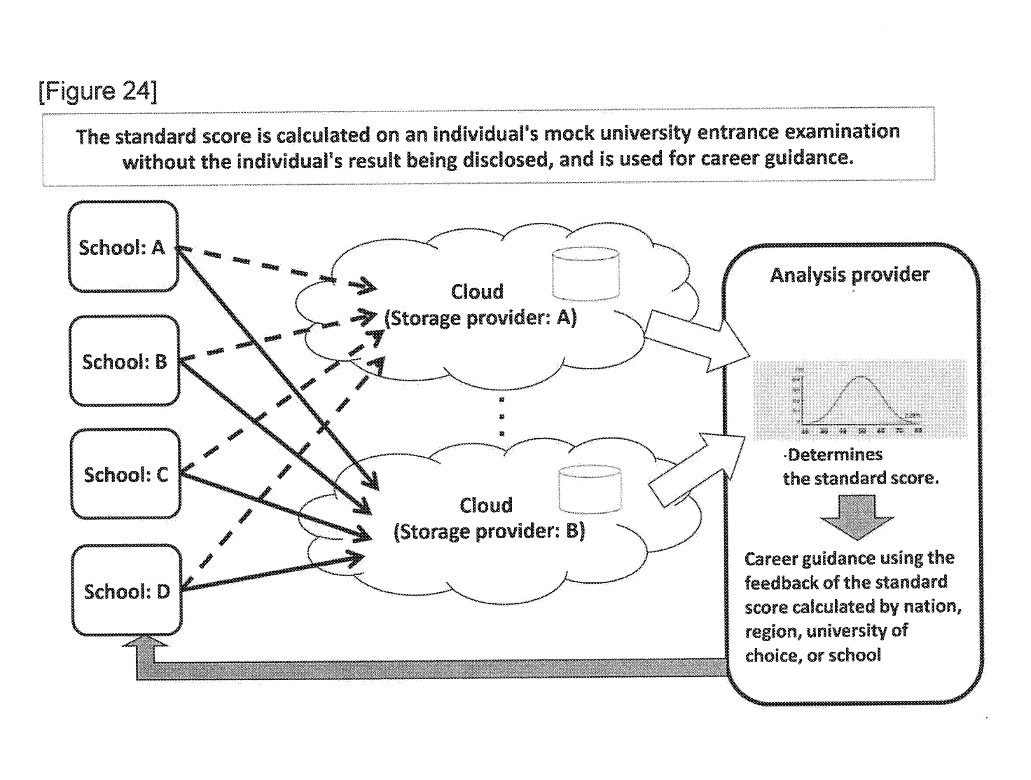

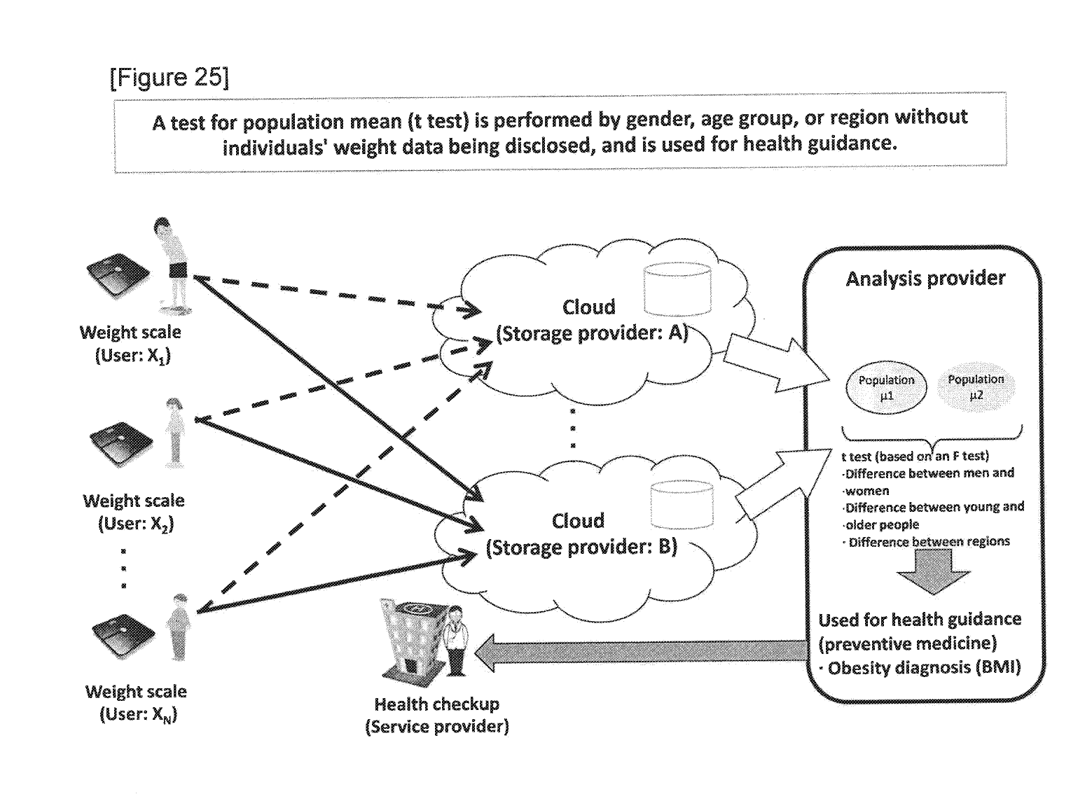

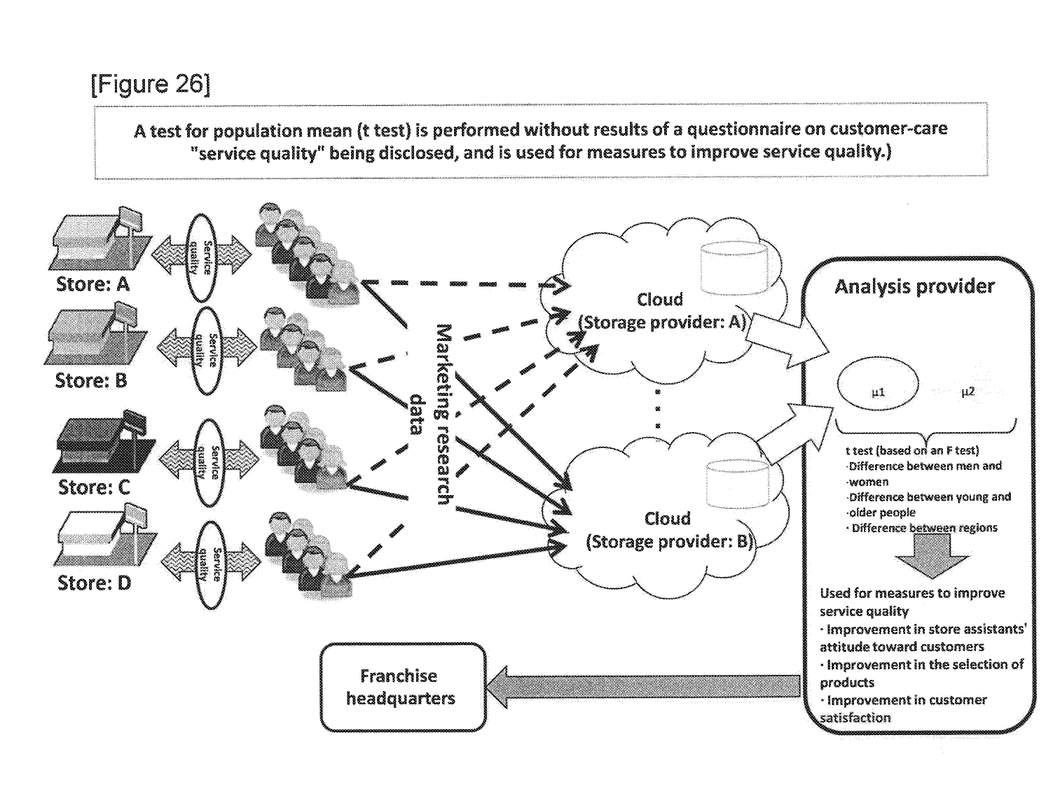

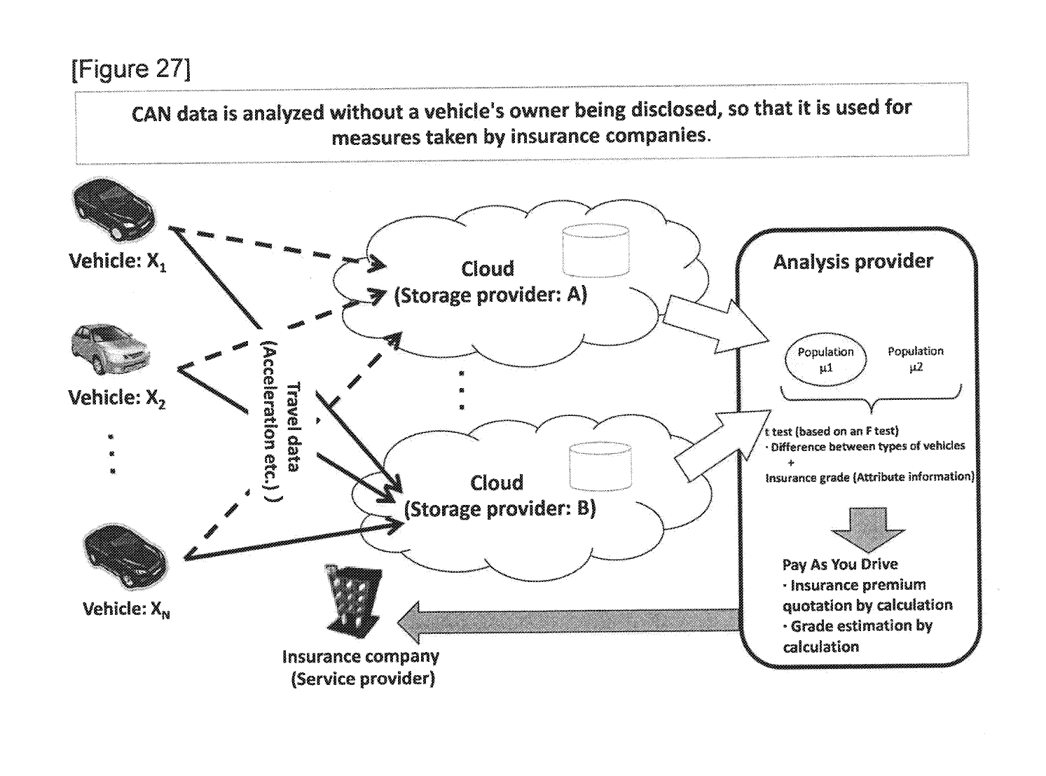

FIGS. 24 to 27 illustrate a small part of potential applications of the present system. FIG. 24 is an application to the field of education, and the present system can be applied to statistical processing, for example, of online tests, mock examinations, or the like. FIG. 25 is an application to the field of medicine (healthcare), and the present system can be applied to statistical processing, for example, of blood pressure, weight, body fat, or the like. FIG. 26 is an application to the field of distribution, and the present system can be applied not only to it but also to statistical processing, for example, in anonymous questionnaire surveys such as surveys of the current living conditions. FIG. 27 is an application to the field of telematics (vehicles), and the present system can be applied to statistical processing, for example, of speed, acceleration, or other travel information, and can also be applied to risk management in other fields, or the like.

While embodiments of the invention have been illustratively described, the invention is not limited by the description herein and it is a matter of course that various changes and applications may be made thereto as appropriate within the scope of the invention by those skilled in the art.

1.-33. (canceled)

34. A data-hidden statistical processing system comprising:
a plurality of data input devices, each comprising means for acquiring an original data item to be hidden;
a plurality of arithmetic devices, each comprising means for performing a predetermined arithmetic operation based on a plurality of input data items; and
a data processing device comprising means for using a result of an arithmetic operation performed by each of the plurality of arithmetic devices using partial data items as the input data items, each partial data item being a part of the original data item, thereby obtaining a statistical processing result based on a plurality of original data items acquired by the plurality of data input devices without acquiring the original data items.

35. The data-hidden statistical processing system according to claim 34, wherein
the data input devices comprise:
means for generating a predetermined number of partial data items by dividing the original data item in accordance with a secret ratio where adding up all the partial data items restores the original data item; and
means for transmitting each of the predetermined number of partial data items to a corresponding one of the plurality of arithmetic devices through a protected communication channel.

36. The data-hidden statistical processing system according to claim 35, wherein
the arithmetic devices comprise means for transmitting to the data processing device an arithmetic result obtained through a predetermined arithmetic operation based on a plurality of partial data items received from the plurality of data input devices, and
the data processing device comprises means for performing predetermined statistical processing based on a plurality of arithmetic results received from the plurality of arithmetic devices.

37. The data-hidden statistical processing system according to claim 36, wherein
the predetermined number of partial data items include those generated from the value of each of the partial data items into which the original data item is divided,
the predetermined arithmetic operation performed by the arithmetic devices includes a calculation of the sum of the plurality of partial data items, and
the predetermined statistical processing performed by the data processing device includes a process to calculate the sum of the predetermined number of arithmetic results.

38. The data-hidden statistical processing system according to claim 36, wherein
the predetermined number of partial data items include those generated from the value of each of the partial data items into which the original data item is divided and those generated based on the value of two partial data items different from each other multiplied by each other,
the predetermined arithmetic operation performed by the arithmetic devices includes a calculation of at least one of the sum or the sum of squares of the plurality of partial data items, and
the predetermined statistical processing performed by the data processing device includes a process to calculate the sum of squares of those of the predetermined number of arithmetic results that correspond to the value of each of the partial data items and a process to calculate the sum of those of the predetermined number of arithmetic results that correspond to the value of the partial data items multiplied by each other.

39. The data-hidden statistical processing system according to claim 36, wherein
the predetermined number of partial data items include those generated from the value of a square of each of the partial data items into which the original data item is divided and those generated based on the value of two partial data items different from each other multiplied by each other,
the predetermined arithmetic operation performed by the arithmetic devices includes a calculation of the sum of the plurality of partial data items, and
the predetermined statistical processing performed by the data processing device includes a process to calculate the sum of the predetermined number of arithmetic results.

40. The data-hidden statistical processing system according to claim 34, wherein
the result of the statistical processing obtained by the data processing device is the result of at least one of: calculation of sample mean; calculation of sample variance; calculation of sample deviation; maximum likelihood estimation; interval estimation using the t distribution; estimation of a confidence interval for population proportion; estimation of population variance; a test for population mean; a test for the population mean difference between populations A and B; a test for population proportion; a comparison test for population variances of populations A and B; and analysis of variance.

41. The data-hidden statistical processing system according to claim 36, wherein
the plurality of data input devices include a same number of first and second data input devices corresponding to each other,
the first and second data input devices transmit each of the predetermined number of partial data items to a corresponding predetermined number of arithmetic devices among a square number of the predetermined number of the arithmetic devices,
the predetermined arithmetic operation performed by the arithmetic devices includes an arithmetic operation to calculate the inner product of a partial data item row from the first data input devices and a partial data item row from the second data input devices, and
the statistical processing performed by the data processing device includes a process to calculate the sum of the square number of the predetermined number of the arithmetic results received from the square number of the predetermined number of the arithmetic devices.

42. The data-hidden statistical processing system according to claim 34, wherein
the result of the statistical processing obtained by the data processing device is the result of at least one of: calculation of covariance; calculation of correlation coefficient; and regression analysis.

43. The data-hidden statistical processing system according to claim 35, wherein
the data input devices further comprise means for determining the secret ratio by using a random number generated when the original data item is divided, and erasing the memory of the secret ratio after the division.

44. The data-hidden statistical processing system according to claim 34, wherein
the data processing device comprises:
means for indicating to each of the plurality of data input devices which of the plurality of arithmetic devices the data input device is to transmit the partial data items to; and
means for indicating to each of the plurality of arithmetic devices which of a plurality of partial data items received from the plurality of data input devices a predetermined arithmetic operation is to be performed on.

45. The data-hidden statistical processing system according to claim 34, wherein
each of the plurality of data input devices comprises means for determining which of the plurality of arithmetic devices the partial data items is to be transmitted to, and
each of the plurality of arithmetic devices comprises means for determining which of a plurality of partial data items received from the plurality of data input devices a predetermined arithmetic operation is to be performed on.

46. The data-hidden statistical processing system according to claim 34, wherein
the plurality of arithmetic devices separately belong to services provided by providers different from one another, and
the data processing device is operated by a provider different from those of the plurality of arithmetic devices.

47. A server device for providing a statistical processing result, the server device being for a service that provides a result of statistical processing based on a plurality of original data items without acquiring the original data items to be hidden, comprising:
means for communicating with a plurality of arithmetic devices, each having means for performing a predetermined arithmetic operation based on a plurality of input data items;
means for causing each of the plurality of arithmetic devices to perform an arithmetic operation using partial data items as the input data items, each partial data item being a part of the original data item, and acquiring a result of the arithmetic operation; and
means for performing predetermined statistical processing based on arithmetic results obtained from the plurality of arithmetic devices, wherein
the plurality of partial data items are generated by dividing the original data item in accordance with a secret ratio where adding up all the partial data items restores the original data item.

48. A data input device comprising:
means for acquiring an original data item to be hidden;
means for generating a predetermined number of partial data items by dividing the original data item in accordance with a secret ratio where adding up all the partial data items restores the original data item; and
means for transmitting each of the predetermined number of partial data items to a corresponding one of a plurality of arithmetic devices, each having means for performing a predetermined arithmetic operation based on a plurality of input data items, through a protected communication channel, as one of the plurality of input data items, wherein
by a server device different from the plurality of arithmetic devices using a result of the predetermined arithmetic operation performed by each of the plurality of arithmetic devices based on partial data items from a plurality of data input devices, a result of statistical processing based on a plurality of original data items acquired by the plurality of data input devices is obtained with the original data items being hidden.

49. The data input device according to claim 48, further comprising:
means for causing the transmitted predetermined number of partial data items to be stored in their respective corresponding arithmetic devices as being able to be accessed only by a permitted person; and
means for erasing the memory of the acquired original data item, wherein
the original data item is restored based on the predetermined number of partial data items acquired from their respective arithmetic devices by the permitted person.

50. The data input device according to claim 48, further comprising:
means for storing information for access to the server device; and
means for receiving information for identifying the corresponding arithmetic device from the server device.

51. The data input device according to claim 48, further comprising:
means for assigning identification information unique in a system to the partial data items; and
means for identifying the corresponding arithmetic device in accordance with which of the scopes separately covered by the respective arithmetic devices a value determined based on the identification information belongs to.

52. A program for causing a computer having a function to communicate with other computers to operate as a data processing device in a data-hidden statistical processing system, wherein
as the other computers there are a plurality of arithmetic devices, each having means for performing a predetermined arithmetic operation based on a plurality of input data items, and
the data processing device provides a result of statistical processing based on a plurality of original data items without acquiring the original data items to be hidden,
the program causing the computer to comprise:
means for causing each of the plurality of arithmetic devices to perform an arithmetic operation using partial data items as the input data items, each partial data item being a part of the original data item, and acquiring a result of the arithmetic operation; and
means for performing predetermined statistical processing based on arithmetic results obtained from the plurality of arithmetic devices, wherein
the plurality of partial data items are generated by dividing the original data item in accordance with a secret ratio where adding up all the partial data items restores the original data item.

53. A program for causing a computer having functions to acquire an original data item to be hidden and to communicate with other computers to operate as a data input device in a data-hidden statistical processing system, wherein
as the other computers there are a plurality of arithmetic devices, each having means for performing a predetermined arithmetic operation based on a plurality of input data items,
the program causing the computer to comprise:
means for generating a predetermined number of partial data items by dividing the original data item in accordance with a secret ratio where adding up all the partial data items restores the original data item; and
means for transmitting each of the predetermined number of partial data items to a corresponding one of the plurality of arithmetic devices through a protected communication channel as one of the plurality of input data items, wherein
by a server device different from the plurality of arithmetic devices using a result of the predetermined arithmetic operation performed by each of the plurality of arithmetic devices based on partial data items from a plurality of data input devices, a result of statistical processing based on a plurality of original data items acquired by the plurality of data input devices is obtained with the original data items being hidden.

54. A service method for providing a statistical processing result, the method comprising that:
each of a plurality of data input devices comprising means for acquiring an original data item to be hidden outputs a predetermined number of partial data items obtained by dividing the original data item in accordance with a secret ratio where adding up all the partial data items restores the original data item;
each of a plurality of arithmetic devices comprising means for performing a predetermined arithmetic operation based on a plurality of input data items outputs a result of the arithmetic operation performed using partial data items as the input data items, each partial data item being outputted from each of a plurality of data input devices; and
a data processing device uses arithmetic operation results, each result being outputted from each of the plurality of arithmetic devices, thereby obtaining a statistical processing result based on a plurality of original data items acquired by the plurality of data input devices without acquiring the original data items.
